(19) United States
(12) Patent Application Publication
(10) Pub. No.: US 2008/0000215 A1
(43) Pub. Date: Jan. 3, 2008

(54) ENGINE SYSTEMS AND METHODS

(76) Inventor: Ronnie J. Duncan, Entiat, WA (US)

Correspondence Address: BLACK LOWE & GRAHAM, PLLC, 701 FIFTH AVENUE, SUITE 4800, SEATTLE, WA, 98104, US

(21) Appl. No.: 11/735,128

(22) Filed: Apr. 13, 2007

Related U.S. Application Data
(63) Continuation-in-part of application No. 11/016,702, filed on Dec. 16, 2004, now abandoned.
(63) Continuation-in-part of application No. 10/172,406, filed on Jun. 14, 2002, now Pat. No. 6,658,838.
Application No. 10/172,406 is a continuation of application No. 09/517,130, filed on Mar. 2, 2000, now Pat. No. 6,430,919.
(63) Continuation-in-part of application No. 10/261,097, filed on Sep. 30, 2002, now Pat. No. 6,684,825.
(62) Division of application No. 09/850,937, filed on May 7, 2001, now Pat. No. 6,484,687.
(63) Continuation-in-part of application No. 10/261,102, filed on Sep. 30, 2002, now Pat. No. 6,672,275.
Application No. 10/261,102 is a division of application No. 09/850,937, filed on May 7, 2001, now Pat. No. 6,484,687.
(63) Continuation-in-part of application No. 10/261,174, filed on Sep. 30, 2002, now Pat. No. 6,782,866.
Application No. 10/261,174 is a division of application No. 09/850,937, filed on May 7, 2001, now Pat. No. 6,484,687.
(60) Provisional application No. 60/745,597, filed on Apr. 25, 2006.

(51) Int. Cl. F02B 1/06

(52) U.S. Cl. 60/204

(57) ABSTRACT

The present invention relates generally or preferably to pulsed hypersonic compression waves and more particularly to shaped charge devices using pulsed hypersonic compression waves to create thrust, two-cycle internal and external combustion engines, rotary machines and more specifically to internal and external rotary combustion engines, fluid compressors, vacuum pumps, and drive turbines for expandable gases or pressurized fluid and water, as well as hydrogen. Other systems include machines and procedures employed during in-process drying of moisture-laden materials employing a reaction chamber forming a pressurized and heated gas.

### PRIORITY CLAIM

This application claims priority to U.S. Patent provisional application Ser. No. 60/745,597 filed Apr. 25, 2006.

This application is a continuation-in-part of and claims priority to U.S. patent application Ser. No. 11/016,702 filed Dec. 16, 2004.

This application is a continuation-in-part of and claims priority to U.S. patent application Ser. No. 10/172,406 filed Jun. 14, 2002 which claims priority to and is a continuation of U.S. patent application Ser. No. 09/517,130 filed Mar. 2, 2000, now U.S. Pat. No. 6,430,919.

This application also claims priority to and is a continuation-in-part of U.S. patent application Ser. No. 10/261,097 filed Sep. 30, 2002, a divisional of application Ser. No. 09/850,937 filed May 7, 2001.

This application claims priority to and is a continuation-in-part of U.S. patent application Ser. No. 10/261,102 filed Sep. 30, 2002, a divisional of application Ser. No. 09/850,937 filed May 7, 2001.

This application is also a continuation-in-part of U.S. application Ser. No. 10/261,174 filed Sep. 30, 2002, which claims priority to and is a divisional of U.S. application Ser. No. 09/850,937 filed May 7, 2001 (U.S. Pat. No. 6,484,687 issued Nov. 26, 2002).

Each application referenced above are incorporated by reference in their entirety as if fully set forth herein.

### STATEMENT OF RELATED CASES

The invention in this application can be used in conjunction with the related inventions disclosed in the applicant's co-pending and commonly assigned applications of related cases:

U.S. patent application Ser. No. 10/261,174 filed Sep. 30, 2002 which claims priority to and is a continuation of U.S. patent application Ser. No. 09/850,937 filed May 7, 2001, now U.S. Pat. No. 6,484,687;

U.S. patent application Ser. No. 10/261,102 filed Sep. 30, 2002 which claims priority to and is a continuation of U.S. patent application Ser. No. 09/850,937 filed May 7, 2001, now U.S. Pat. No. 6,484,687;

U.S. patent application Ser. No. 10/261,097 filed Sep. 30, 2002 which claims priority to and is a continuation of U.S. patent application Ser. No. 09/850,937 filed May 7, 2001, now U.S. Pat. No. 6,484,687;

PCT Patent application serial number PCT/US02/14414 filed May 7, 2001 which claims priority to and is a continuation of U.S. patent application Ser. No. 09/850,937 filed May 7, 2001, now U.S. Pat. No. 6,484,687, and

PCT Patent application serial number PCT/US01/06617 filed Mar. 2, 2001 which claims priority to and is a continuation of U.S. patent application Ser. No. 09/517,130 filed Mar. 2, 2000, now U.S. Pat. No. 6,430,919.

The above co-pending and commonly assigned applications are herein incorporated by reference in its entirety as if fully set forth herein.

### FIELD OF THE INVENTION

The present invention relates generally or preferably to pulsed hypersonic compression waves and more particularly to shaped charge devices using pulsed hypersonic compression waves to create thrust, two-cycle internal and external combustion engines, rotary machines and more specifically to internal and external rotary combustion engines, fluid compressors, vacuum pumps, and drive turbines for expandable gases or pressurized fluid and water, as well as hydrogen. Other embodiments of the present invention relates to engine system and methods used for drying in process or finished materials.

### BACKGROUND OF THE INVENTION

The full potential of the machine industry has yet to be realized in part because of several deficiencies in functionality, features, performance, reliability, cost-effectiveness, and convenience of existing systems. There is a need for a comprehensively improved engine system and method. The improved system preferably includes improvements and/or features to address one or more, or any combination of the following problems.

In propulsion devices such as jet engines and rocket engines, propulsion thrust is obtained by high-speed exhaust flows. Conventional jet engines obtain the high-speed exhaust by combustion products of fuel and air, while rocket engines obtain the high-speed exhaust by internal combustion products of fuel and oxidizer. The high pressure combustion products are forced through a restrictive orifice, or nozzle, to obtain the high-speed exhaust flow.

Several problems are inherent in the conventional systems. The combustion in both jet and rocket engines must contain extremely high internal pressures and are therefore limited by construction material strength. As the internal combustion pressure increases, the combustion chamber wall must increase in thickness to contain the pressure, increasing the combustion chamber weight proportionally and limiting the design. Also, as the exhaust nozzle diameter is reduced to increase exhaust speed, cooling the engine and nozzle becomes increasingly more difficult. In addition, pulsed engines are unable to evacuate the combustion products in a short time moment, thus limiting the firing speed.

Furthermore, as internal pressure in the combustion chamber increases, higher fuel and oxidizer inlet pressures are required to introduce fuel and oxidizer into the combustion chamber, requiring heavier weight pumps that operate at higher horsepower. One example of such limitations on present engines is seen in the phase two main space shuttle engine. The engine requires 108,400 horsepower to drive the fuel and oxidizer pumps alone. Inlet pressures exceed 6,800 psi in order to obtain an internal combustion chamber pressure to only 3,260 psi with a combustion chamber to nozzle ratio of 77 to 1.

The huge plume of fire trailing the shuttle and other rockets is caused by incomplete combustion of the fuel and oxidizer prior to exiting the exhaust nozzle. The fuel and oxidizer igniting outside the engine provide virtually no thrust and are thus wasted. The above space shuttle engine example requires 2,000 pounds of fuel and oxidizer per second to obtain 418,000 pounds thrust at sea level. Furthermore, the continuous ignition of present engines causes high heat transfer to engine parts, particularly the nozzle orifice, and the high heat transfer requires the use of costly exotic materials and intricate cooling schemes to preserve the engine structure.

Prior efforts to improve the engine design focus on various components, including the nozzle. For example, U.S. Pat. No. 6,003,301 to Bratkovich et al., entitled “Exhaust Nozzle for Multi-Tube Detonative Engines” teaches the use of a nozzle in an engine having multiple combustor tubes and a common plenum communicating with the combustor tubes. Accordingly, Bratkovich et al. teach that the common plenum and a compound flow throat cooperate to maintain a predetermined upstream combustor pressure regardless of downstream pressure exiting the expansion section.

While the prior art addresses many aspects of propulsion devices, it does not teach the use of a shaped charge in a jet or rocket engine. A shaped charge is generally defined as a charge that is shaped in a manner that concentrates its explosive force in a particular direction. While the general theory behind shaped charges has been known for many years, the prior art has restricted the use of shaped charges to warheads and certain other expendable detonation devices. In a typical warhead, the shaped charge directs its explosive forces forwardly, in the direction the warhead is traveling, by igniting moments before or substantially simultaneously with impact. The highly concentrated force can be used to create a cheap, lightweight armor-piercing device. Examples of shaped charge devices are described in U.S. Pat. No. 5,275,355 to Grosswendt, et al., entitled “Antitank Weapon For Combating a Tank From The Top,” and U.S. Pat. No. 5,363,766 to Brandon, et al., entitled, “Ramjet Powered, Armor Piercing, High Explosive Projectile.” Shaped charges in such devices are not used to provide propulsion.

Similarly, current engines configured to drive a turbine do not employ shaped charge engines. One example of a pulsed turbine engine is disclosed in U.S. Pat. No. 6,000,214 to Scragg, entitled “Detonation Cycle Gas Turbine Engine System Having Intermittent Fuel and Air Delivery.” Scragg teaches a detonation cycle gas turbine engine including a turbine rotor within a housing. Valveless combustion chambers are positioned on either side of the rotor to direct combustion gases toward the turbine blades. The two combustion chambers alternately ignite the mixture of fuel and oxidizer to cyclically drive the turbine. While Scragg discloses a useful engine, efficiency, horsepower per unit of engine weight, and other performance parameters could be greatly improved. For example, the Scragg device constructed to deliver 200 hp would require a 560 cubic inch combustion chamber and would weigh 262 pounds, while a 200 hp engine using a shaped charge as in the present invention would require a combustion chamber of only 18 cubic inches and would weigh only 70 lbs.

There is therefore a need for a shaped charge propulsion device that provides substantially improved performance than prior art devices.

Conventional two-cycle or two-stroke engines require the use of aerosolized oil-in-gas fuels to lubricate the moving parts of the crankshaft and piston assemblies. The crankcase also functions as an air-fuel chamber to receive aerosolized oil-in-fuel charges from a carburetor and deliver the aerosolized oil-in-fuel charges to the combustion chamber through the selective unmasking of sleeve ports as the piston reciprocates in the combustion chamber. Because two-cycle engines have one power stroke for every crankshaft revolution, compared to four-cycle engines that have one power stroke for every two-crankshaft revolutions, two-cycle engines have more power per weight. Accordingly, two-cycle engines have found useful applications in hand-operated devices prone to significant tilting (chainsaws, weed-eaters) and in small engines (outboard motors, lawnmowers, snowmobiles, and motorcycles).

However improved in power efficiency, the use of aerosolized oil-in-gas premixed fuels comes at the expense of increased hydrocarbon (HC), Nitrogen Oxides (NOx), and carbon monoxide (CO) pollutant emissions due to the greater difficulty in combusting the lubricating oil pre-mixed in the gasoline. Furthermore, two-cycle engines are fuel inefficient because a portion of the incoming air-fuel charge is used to displace the exhaust is unavoidably short circuited to the exhaust port.

Emission regulations governing two-cycle engines (for example, the California Air Resource Board) now require HC, NOx, and CO levels to be reduced by approximately two-thirds and for two-cycle engines and to have improved fuel economy. Thus, there is a need to have a two-cycle engine with improved combustion and fuel efficiencies to lower pollutant emissions and optimize fuel economy.

As the human race has evolved throughout the centuries, we, as a people, have used our minds to develop machines and tools to help us achieve higher evolutionary standards. Technological advances include the invention and discovery of the lever and the wheel in early times to more sophisticated communication and computational devices that we now enjoy in our daily lives. Nearly all aspects of technology, from the very rudimentary to the very complex, have made great advances that have made the daily lives of the people and animals on this planet much easier. However, there is one invention that has been with us for a long time that has received little technological advancement despite its extremely important use in our daily lives.

A typical four-cycle internal combustion reciprocating engine powers nearly all vehicles on the face of the planet. Likewise, the same engine is employed to powerboats, generators, compressors, pumps, and machines of all type and design. However, despite its widespread use, the internal combustion, or Otto cycle, engine or, in certain instances, a diesel cycle engine, has received very little technological advancement. The changes made to the engine have left the basic thermal cycle of the engine untouched.

The reciprocating motion of common internal combustion engines, Otto and diesel cycle, is an inefficient method of producing rotary power. A typical four-cycle engine requires four reciprocating motions for each unit of power it delivers. Initially, the engine has an intake and compression stroke, followed by combustion, expansion, and exhaust strokes. The reciprocating motion of the four-cylinder engine requires four inertial changes of the rotating mass of the pistons, connecting rods, and assembly—each change in inertia yielding a power loss to the system. Likewise, each complete cycle of the internal combustion engine requires four inertial changes for the associated valves, springs, lifters, rocker arms, and push rods, yielding additional total loss of the engine.

The mechanical complexity of the standard internal combustion engine adds to the design's overall inefficiency. A single cylinder four-cycle engine requires many moving parts, including a piston, piston pin, connecting rod, crank shaft, a plurality of lifters, push rods, rocker arms, valves, valve springs, gears, a timing chain, and a fly wheel. Each one of these parts increases the probability of engine failure due to fatigue or wear. Likewise, this large number of parts increases the amount of inertial mass that must change four times per cycle, reducing power produced by the system. Each moving part is subject to frictional loss between each relative part, adding to power loss. Further, it is expensive to manufacture and maintain equipment requiring such a large number of moving parts.

A typical four-cycle engine is a low torque, high r.p.m. machine. Because the relatively short throw of the crank arm yields a very low tortional moment, the Otto cycle engine requires a higher r.p.m. to achieve higher power ratings. More specifically, both Otto and diesel cycle engines achieve their highest internal pressure at approximately the lowest tortional moment in the piston cycle, top dead center. Thus, the engine cycle does not mate the engine's greatest potential to do work—highest internal pressure—with the engine's best ability to exploit that potential or convert it to power. Further, the torque moment is not constant. Rather, the torque moment is at approximately zero at top dead center, reaches its highest value at mid-stroke, and returns to zero at bottom dead center. By design, the highest internal pressure occurs when the piston is at approximately full stroke or extension. Therefore, a majority of the initial force generated during combustion is transmitted axially down the piston and connecting rod and is not transferred to rotational power. Only subsequently, as the tortional moment enlarges, is a majority of the expansive force converted into rotational power. The resulting structural requirements limit piston assembly design, increasing mass and limiting material choice. Further, transmissions are necessary to amplify the relatively low torque generated by the reciprocating motion, thus adding weight, cost, complexity and additional power requirements to the overall system.

The compression, and thus heating, of the original unit volume of combustion products leads to further power loss. Gas expansion is dependent upon the temperature of the gas prior to ignition—with all other variables held constant, a gas with a cooler ignition temperature will expand more than the same gas at a hotter ignition temperature, given the space to do so. Therefore, the heating of the fuel/air mixture by compression prior to ignition reduces the amount of expansion, and thus work, attainable during the subsequent expansion stroke. Likewise, the reciprocating design limits the combustion product's ability to do useful work because the expansion volume is not equal to the compression volume—combustion heats the gas, thus increasing the expansion volume beyond the initial volume. Thus, relatively high-pressure combustion gases are exhausted without performing any useful work.

The overall design of Otto, diesel, and other rotary engines is limited by cross-leakage at high pressure. More specifically, cross leaking is internal pressure loss due to overflow from the high-pressure side to the low-pressure side of the system while the pistons move throughout their stroke. Leakage generally occurs around the piston and the cylinder walls, exhaust and inlet ports, and between the cylinder head and the block. The excessive number of seals and connecting parts in other internal combustion engines creates cross-leakage liability. Therefore, the operating internal pressure range of the engines is greatly reduced.

Yet, another limitation of current rotary engine technology is the internal combustion design of the engines. More specifically, current rotary engines are operable only as internal combustion engines. The current designs fail to allow for use as external combustion or external detonation cycle engines. Thus, the current state of rotary engine technology requires a considerably larger volume for expansion of the gases than is required with an external aspects of this invention.

A further limitation of current engine technology is a lack of design diversity. The extent of diversity for typical internal engines is limited by a need to drive a common crankshaft from a plurality of reciprocating motions. The engine design has developed little from standard in-line and v-type engine configurations. Even other rotary engine designs are singular in their rotary component arrangements. Alternative piston arrangements, such as cross rotation, have not been explored. This limited design diversity prevents possible space-saving designs from being developed.

Another design limitation of the internal combustion engine is the singularity of its use. The internal combustion engine is operable only as an internal combustion engine. It is a power source converting chemical energy into mechanical energy, the mechanical energy being in the form of a rotating shaft. The internal combustion engine itself has no ability to function with detonation chambers other than the internal combustion chamber, such as, for example, a shaped charge or other detonation cycle device, some of which provide external combustion. Furthermore, the internal combustion engine itself is incapable of functioning as an air compressor, a vacuum pump, an external combustion engine, water pump, a drive turbine for expandable gas, or a drive turbine.

Hydrogen has been well recognized as the fuel of the future. It has high energy value and its products are nonpolluting. However, current methods to produce hydrogen use fossil fuels and high temperatures to produce the hydrogen. Furthermore, these methods produce carbon dioxide and NOx, thus negating any environmental advantages. Biological processes to produce hydrogen are intriguing, but considerable technical challenges still exist. A major challenge is to have high rates of hydrogen production and still use an inexpensive energy source for the biological production. Photosynthetic methods can employ solar radiation, but the hydrogen production is too slow to be of use. Fermentation methods can produce hydrogen at high rates, but require expensive energy sources such as glucose. Biomass would seem to be ideal as source of glucose, however, the problem with biological hydrogen production is the same as with biological ethanol production from biomass: inefficient degradation of the cellulosic material containing the glucose.

As relates to machines and systems employed during in-process drying procedures, there is a need for manufacturers of food supplies and other materials have for a more efficient system for methods for drying in-process and finished products.

### SUMMARY OF THE PARTICULAR EMBODIMENTS

Embodiments in the disclosure herein provides a shaped charge engine that overcomes many limitations of the prior art. The apparatus includes a blast-forming chamber comprising an inner annular charge forming housing having a conical convex projection that forms the inner walls of the blast-forming chamber. A central through hole is provided to allow exhaust gases to exit. An outer housing comprises a generally round disk with an inner conical concave depression and through holes for the insertion of fuel and ignition. The two housings are joined by conventional means such as welding or bolts. The resulting chamber formed by joining the two housings is taper-conical in shape, wider at the base, and gradually decreasing in cross-sectional area as it rises to the apex. This construction forms a circular pinch point or throat toward the apex that forms the primary or first stage compression area. A secondary compression zone is created at the apex of the outer housing, just beyond the throat. Hypersonic gases exit the through hole in the inner housing.

As relates to machines and systems employed during in-process drying procedures, systems for drying moisture-laden materials employing a reaction chamber forming a pressurized and heated gas are described. The systems employ a pressurized feeder hopper to direct moisture laden materials into the pressurized and heated gases emerging from the reaction chamber, and a drying tube configured to receive streams of the moisture laden and pressurized materials to hasten drying by granulizing processes imposed upon the hopper-introduced materials.

### BRIEF DESCRIPTION OF THE DRAWINGS

The particular embodiments are described in detail with reference to the following drawings.

FIG. 1 is a cross-sectional view of a shaped charge engine, including a blast-forming chamber, formed in accordance with a preferred embodiment of the present invention;

FIGS. 2A-C is a cross-sectional view of several representative shapes of a blast-forming chamber formed in accordance with the present invention;

FIGS. 3A-C is a cross-sectional view of several representative orientations of a blast-forming chamber formed in accordance with the present invention;

FIGS. 4A and 4B are cross-sectional view of two alternate configurations for the throat of an engine formed in accordance with the present invention;

FIG. 5 is a representative view of a switchable jet and rocket engine formed in accordance with the present invention;

FIG. 6 is a representative view of a pulse driver engine formed in accordance with the present invention;

FIG. 7A is a side view of a rotary centrifugal throttle valve formed in accordance with the present invention;

FIG. 7B is a top view of rotary centrifugal throttle valve formed in accordance with the present invention;

FIG. 8 is a cross-sectional isometric view of a two-cycle engine equipped with a fuel injector;

FIG. 9 is a cross-sectional view of the combustion chamber and air intake space when the piston is at top dead center in the two-cycle engine equipped with a fuel injector;

FIG. 10 is a cross-sectional view of the combustion chamber and air intake space when the piston is at bottom dead center in the two-cycle engine equipped with a fuel injector;

FIG. 11 is a cross-sectional view of the combustion chamber and air intake space when the piston is at top dead center in a two-cycle engine equipped with a carburetor;

FIG. 12 is a cross-sectional view of the combustion chamber and air intake space when the piston is at bottom dead center in a two-cycle engine equipped with a carburetor;

FIG. 13 is a semi-exploded isometric view of a rotary machine;

FIG. 14 is a sectional frontal view of rotary components;

FIG. 15 is an exploded isometric view of the external combustion aspect of the invention;

FIG. 16 is an exploded isometric view of the shaped charge or other detonation cycle external combustion aspect of the invention;

FIG. 17 is a sectional isometric view taken along line 5-5 of FIG. 14, of some rotary components;

FIG. 18 is a sectional isometric view taken along line 6-6 of FIG. 13, of some rotary components;

FIG. 19 is a sectional isometric view taken along line 7-7 of FIG. 14, of some rotary components;

FIG. 20 is a sectional isometric view taken along line 8-8 of FIG. 13, of some rotary components;

FIG. 21 is a isometric view of a multi-cylinder aspect of the invention;

FIG. 22 is a frontal view of a multi-firing aspect of the invention;

FIG. 23 is a frontal view of a state in the rotary cycle;

FIG. 24 is a frontal view of a state in the rotary cycle;

FIG. 25 is a frontal view of a state in the rotary cycle;

FIG. 26 is a frontal view of a state in the rotary cycle;

FIG. 27 is a graphical view of the thermal cycles;

FIG. 28 illustrates the design of the hydrogen producing system;

FIG. 29 is a side view schematic of an embodiment of the drying system;

FIG. 30 is a cross-sectional view of a pulse combustion chamber device;

FIG. 31 is an isometric and exploded view of a pressure feeder connectable with the combustion chamber used to introduce materials for drying into the exhaust gases emerging from the pulse combustion chamber;

FIG. 32 is isometric view of a coil drying tube connectable with the pressure feeder of FIG. 31;

FIG. 33 is a side view of an alternate embodiment of the coil drying tube;

FIG. 34 is an is an isometric and exploded view side view of an ingress or egress pressure feeder connectable with a pressure reservoir;

FIG. 35 depicts a side view and cross-sectional illustration of an ingress pressure feeder connected to a pressure reservoir; and

FIG. 36 depicts a side view and cross-sectional illustration of an ingress and egress pressure feeder connected to a pressure reservoir.

### DETAILED DESCRIPTION OF THE PARTICULAR EMBODIMENTS

Particular embodiments described herein include a shaped charge engine that overcomes many limitations of the prior art. The apparatus includes a blast-forming chamber comprising an inner annular charge forming housing having a conical convex projection that forms the inner walls of the blast-forming chamber. A central through hole is provided to allow exhaust gases to exit. An outer housing comprises a generally round disk with an inner conical concave depression and through holes for the insertion of fuel and ignition. The two housings are joined by conventional means such as welding or bolts. The resulting chamber formed by joining the two housings is taper-conical in shape, wider at the base, and gradually decreasing in cross-sectional area as it rises to the apex. This construction forms a circular pinch point or throat toward the apex that forms the primary or first stage compression area. A secondary compression zone is created at the apex of the outer housing, just beyond the throat. Hypersonic gases exit the through hole in the inner housing.

In accordance with further aspects of the invention, a directed thrust is formed in a pulsed manner using a contained burn that starts at a peripheral base area and is directed in a tapered-conical shape that forms a primary compression area adjacent the apex of the conical shape. The compressed burn thereafter continues to the apex of the tapered-conical shape, creating a high-speed convergence or secondary compression zone before being exhausted. This construction provides a more complete ignition within the chamber, enhancing efficiency by capturing more of the energy before it leaves the engine. It also allows for the combustion products to exit the primary combustion chamber more rapidly, thus allowing a higher pulse rate of firing while maintaining the high compression exhaust flows by not compressing exhaust products to final velocity internally.

In accordance with other aspects of the invention, the engine includes a sensor to determine the ambient air density, allowing the engine to selectively consume air or oxidizers, as appropriate.

In accordance with still further aspects of the invention, inexpensive conventional fuels, such as gasoline, acetylene, butane, propane, natural gas, and diesel oil are mixed with air or an oxidizer into a combustible mixture and infused under positive pressure into the hollow blast-forming chamber in a manner that permits positive shutoff between a series of induction cycles to accommodate ignition cycles.

In accordance with yet other aspects of the invention, an igniter ignites the combustible mixture initiating a blast wave or pulse at the base of the hollow blast-forming chamber. As the blast wave or pulse advances into a gradually compressed blast-forming chamber, additional mass may be injected into the blast chamber, thereby increasing the momentum of the blast wave. Explosion products are compressed by the gradually decreasing cross sectional area of the blast-forming chamber. The increasing pressure drives the blast wave into a primary compression zone formed by an annular restriction between the truncated end of a central conical projection and an opposing truncated hemispherical or domed inner surface of the outer housing.

Compression of the blast wave into this annular restriction creates a high-speed radial flow of explosion products toward the center of the truncated hemispherical or domed surface. The opposing high-speed radial streams of explosion products converge at the center of the truncated hemispherical or domed surface creating a secondary zone of increased compression of the explosion products. Confluence of mass and kinetic energy in the secondary compression zone forms the explosion products into hypersonic gases that exit in a controlled blast directed through an exhaust port centrally located at the apex of the central conical projection. The resulting high pressure hypersonic exhaust is expelled in a directed blast from the exhaust port without the need for an exit nozzle.

In accordance with still another aspect of the invention, the exit velocity of the combustion products and ejecta is controlled by increasing or decreasing the size, length, diameter, and depth angle of the blast chamber, and adjusting fuel-oxidizer mixtures.

In accordance with still further aspects of the invention, the controlled blasts formed in the blast-forming chamber are repeatable by the serial infusion and ignition of additional charges of the combustible mixture. Furthermore, in repeating pulsed modes, the blast power and frequency are throttle controllable by increasing or decreasing the flow rate of the combustible mixture or adjusting the cycle rate independently of the mixture flow rate.

In accordance with yet another aspect of the invention, the engine is operated in a pulsed mode along a continuum between an aerobic or air-breathing jet mode and an anaerobic or non-air-breathing rocket mode. Accordingly, fuel is mixed with air, oxidizer, or any combination of the two in any relative concentration. The relative concentrations of air and oxidizer in the combustible mixture is dynamically adjusted into a blend of air and oxidizer, which may be a function of oxygen concentration in the ambient atmosphere.

In accordance with further aspects of the invention, the particular geometry of the shaped charge engine may be varied, while still retaining the inventive aspects, including primary and secondary convergence zones. Accordingly, the cross-sectional shape may be annular, square, rectangular, triangular, or a variety of other forms depending on the desired results and the space available to house the engine in the vehicle to be propelled.

In accordance with still further aspects of the invention, the exhaust gases collide at a secondary convergence zone to create hypersonic exhaust. The opposing streams of gases may originate in chambers that are substantially opposite one another and at least partially orthogonal to the direction of travel. Alternatively, the blast chamber may be configured such that the explosive products travel in an acute or an obtuse angle with respect to the direction of travel before reaching the throat and the secondary compression zone.

In accordance with additional aspects of the invention, the angle at which the exhaust gases converge may be dynamically controlled during operation of the engine. The generally opposed sides of the generally annular blast-forming chamber may be hinged to allow the chambers to be moved fore and aft to adjust the angle of convergence.

In accordance with yet other aspects of the invention, the cross-sectional area of the throat or pinch point may be increased or decreased. By decreasing the size of the throat area, the exhaust gases travel at a higher velocity, creating a relative spike in the exhaust velocity and therefore the thrust. Conversely, by increasing the throat size, the exhaust gases exit more uniformly and at a lower relative velocity.

In accordance with other aspects of the invention, the engine may be used to provide direct thrust to propel a rocket, aircraft, personal water craft, or other vehicle.

In accordance with still other aspects of the invention, the exhaust gases created by the engine may be used to drive a turbine that is used to propel the vehicle. In such an embodiment, the engine may, for example, be used to power a car.

In accordance with still further aspects of the invention, the pressure, exhaust, pulse, or heat produced by the shaped charge engine may be used in a wide variety of applications, including, for example, vehicle propulsion, pest control, demolition, cutting tools, etching tools, heating tools, spraying tools, high-speed guns, generators, boilers, and closed-system pressure devices.

The preferred embodiment of the present invention provides for an improved combustion and fuel efficient two-cycle engine that realizes fuel economy and efficiency in two ways—first, by the use of oil-less fuels, and second, by avoiding fuel losses attributable to air-fuel short-circuiting or shunting to the exhaust port.

The two-cycle engine uses a two lateral-sided piston that reciprocates between a combustion chamber fitted with a fuel injector and an air intake space continuous with the combustion chamber. One of the lateral side functions to compress air-fuel charges in the combustion chamber, and the other lateral side functions to draw-in and compress air-charges in the air space for delivery to the combustion chamber.

The combustion chamber is equipped with a fuel injector or atomizer and an ignition source, an air inlet port, and a combustion gas exhaust port. The fuel injector delivers oil-less fuel in an aerosolized or atomized state after the exhaust port is sealed or occluded by the cylinder side of the piston. Beneath the air intake chamber is the crankcase that houses the crankcase assembly. A fixed disk or crankcase divider having an aperture separates the air intake space from the crankcase. The disk aperture is slidably and sealably engaged with a piston extension that is connected to the crankcase assembly. The separated crankcase allows independent lubrication of the crankcase and piston assemblies, and accordingly the use of oil-less fuels in the two-cycle engine.

The reciprocating motion of the piston functions as a two-sided pump between the compression chamber and the air intake space. Upon receiving motion transmitted from the crankcase assembly, the compression chamber side of the piston compresses oil-less air charges with injected oil-less fuel for ignition in the combustion chamber. At the same time, the air intake space side of the piston replenishes the air intake space with a new air charge with vacuum-like suction. When ignition of the air-fuel charge occurs and combusted gases expand, the piston is driven toward the crankcase divider and transmits motion to the crankcase assembly.

The air intake chamber side of the piston then compresses and delivers the replenished air charge to the combustion chamber via channels and the coordinated action of valves. A portion of incoming air charge displaces the exhaust products of the expanded gases, made during a prior ignition, from the combustion chamber through the exhaust port. As the piston approaches top dead center, the exhaust port is closed first, then the remaining incoming air charge is mated and compressed with a fuel injection charge from the fuel injector. The oil-less fuel is injected into the combustion chamber in a dispersed or aerosolized state after the exhaust and inlet ports are closed. It is the incoming air charge that is used for sweeping or displacing the previous combustion's cycle products to the exhaust port, and thus only a portion of the air charge that is lost to exhaust port short-circuiting. Because the exhaust port is closed after air charge displacement and air charge short-circuiting and before oil-less fuel injection, fuel short-circuiting to the exhaust port is avoided.

The dispersed oil-less air-fuel mixture is ignited for combustion, the piston is displaced in a power stroke by the expanding gases from the ignited air-fuel mixture, and another replacement air charge, previously drawn into the intake space, is compressed during the power stroke and delivered to the combustion chamber to recharge the combustion chamber with air and to displace the spent combustion gases.

An alternate embodiment of the two-cycle engines uses oil-less fuels that are premixed with air by an attached carburetor that routes the oil-less air-fuel charge to the air chamber space, and via downwardly compressing piston action, then to the combustion chamber not fitted with a fuel injector. As there is some air-fuel exhaust port short-circuiting, fuel economy in the alternate embodiment is realized primarily by the use of oil-less fuels.

The present invention further comprises a rotary machine capable of functioning as an internal or external rotary combustion engine, shaped charge or detonation charge rotary engine, fluid compressor, vacuum pump, or drive turbine for expandable gases or pressurized fluid and water. In accordance with some aspects of the invention, the rotary machine employs a generally toroidal-shaped housing that is cylindrical in shape at its perimeter. Disposed substantially within the toroidal housing and integrally connected to the housing is a plurality of rotary components, including an expansion ring having an expansion ring projection that cooperates with a sealing cylinder having a recess that mechanically mates with the expansion ring projection.

In accordance with other aspects of the invention, the invention includes intake and exhaust ports that, depending upon the function the rotary machine is performing, allow various gases, fuels, or fluids to enter or exit a chamber defined within the rotary machine.

In accordance with further aspects of the invention, when functioning as an internal combustion machine, combustion products entering the intake port are not compressed by the combustion chamber prior to ignition.

In accordance with other aspects of the invention, in some embodiments the expansion ratio is greater than the compression volume.

In accordance with still further aspects of the invention, the exhaust gases are exhausted at any desirable exhaust pressure, including ambient pressure.

In accordance with yet other aspects of the invention, the toroidal housing prevents pressure loss due to cross leaking.

In accordance with still further aspects of the invention, the torque moment is constant throughout the cycle, but the torque value decreases with decreasing pressure.

In accordance with still further aspects of the invention, the constant torque moment allows the rotary machine to operate at relatively low r.p.m. while achieving relatively high power output.

In accordance with yet other aspects of the invention, the highest torque moment coincides with the highest compression or internal pressure.

In accordance with yet other aspects of the invention, the torque value and r.p.m. are independent variables that may be manipulated to achieve a desired power output.

In accordance with still further aspects of the invention, the compression ratio is independent and may be adjusted to achieve a desired output.

In accordance with still further aspects of the invention, the relative motion of the piston and output shafts is adjustable to any configuration.

In accordance with yet other aspects of the invention, ignition timing is variable to achieve a desirable combustion pressure.

In accordance with still further aspects of the invention, a variety of ignition devices are employable with the rotary machine, for example, transformer discharge systems, voltage devices, spark plugs, photoelectric cell, piezoelectric and plasma arc devices.

In accordance with yet other aspects of the invention, the rotary machine produces bi-directional rotational power that may be employed separately or conjunctively.

In accordance with still further aspects of the invention, a plurality of rotary machines may be selectively employed to achieve a desired power output.

In accordance with yet other aspects of the invention, a plurality of rotary machines may be selectively employed to achieve a desired vacuum or compression value.

In accordance with yet other aspects of the invention, a new thermal cycle is developed having an intake, expansion and exhaust stroke, without compression of the combustion products within the combustion chamber.

In accordance with yet other aspects of the invention, in some embodiments combustion products are compressed prior to combustion.

In accordance with yet other aspects of the invention, the combustion and expansion chambers are shaped to allow efficient expansion of combustion products with minimal inertial loss.

In accordance with yet other aspects of the invention, piston size and torque moment are variable to achieve desired r.p.m. and power requirements.

In accordance with yet another embodiment of the invention, the biological generation of hydrogen from water has been developed to create a highly efficient combustion engine that would burn cleanly off of a sustainable fuel source.

As relates to machines and systems employed during in-process drying procedures, systems for drying moisture-laden materials employing a reaction chamber forming a pressurized and heated gas are described. The systems employ a pressurized feeder hopper to direct moisture laden materials into the pressurized and heated gases emerging from the reaction chamber, and a drying tube is configured to receive streams of the moisture laden and pressurized materials and hasten drying and to granulize of the hopper-introduced materials.

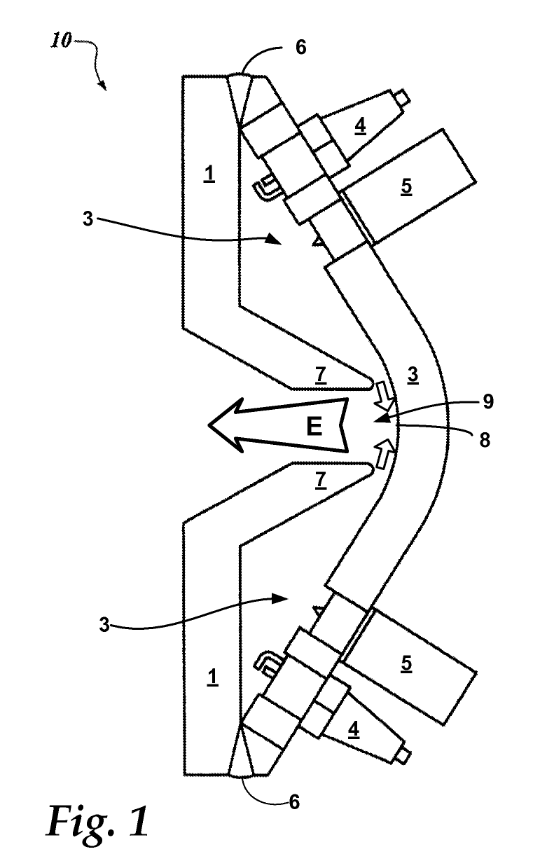

General Construction of the Shaped Charge Engine. FIG. 1 schematically illustrates in cross-section a device constructed in accordance with the present invention for dynamically compressing and detonating a combustible mixture to form a shaped compression wave. Reference numeral 10 generally refers to a shaped charge engine. The engine 10 includes a hollow blast-forming chamber 3 formed between an outer charge forming housing 2 and an inner charge forming housing 1. The outer charge forming housing 2 is generally round-conical in shape and includes a centrally located dome shaped portion at the apex to form a concave “cup” or “bowl” shape.

The inner charge forming housing 1 comprises a generally flat plane transitioning to a centrally located generally conical-shaped projection 7. The projection 7 extends radially inward and upward toward the outer housing 2. The projection 7 is truncated below the tip to form a centrally located generally circular opening at the smaller end of the cone which is nearest the outer housing 2 when the inner housing 1 and outer housing 2 are joined. From the perspective of exhaust gases E traveling from the tip of the projection 7 through the opening and out the engine, the projection 7 thus forms a generally cylindrical opening that flares outward into a generally conical opening at the exit.

The inner charge forming housing 1 is joined to the outer charge forming housing 2 so that the projection 7 extends toward the outer housing 2. The outer charge forming housing 2 and inner charge forming housing 1 are joined along their respective outer peripheral edges to form hollow blast-forming chamber 3 in the space between the inner housing 1 and outer housing 2. The inner and outer charge forming housings 1 and 2 are joined, for example, by a weld 6, or by other compression means such as bolts or rivets.

The housings 1 and 2 are formed of materials capable of withstanding the heat and pressure of the ignition, detonation, and compression of the controlled combustion. Any of a variety of materials typically used in the construction of rocket engines may be used for the present invention, including, for example, steel, stainless steel, or titanium. Preferably, the material of inner charge forming housing 1 is sufficiently thick to withstand the heat and pressure without external support.

A plurality of fuel injectors 5 and igniters 4 project through the outer housing 2 and into the chamber 3. The injectors 5 infuse fuel, air, and oxidizer into hollow blast-forming chamber 3. The preferred combustible mixture is, for example, formed of any conventional fuel that, when mixed with air, oxidizer, or a combination of both, forms a combustible mix. The fuel is optionally any airborne combustible material such as Hydrogen or other flammable gases; an inexpensive liquid spray such as butane, propane, gasoline, acetylene, or natural gas; a combination of vapor and liquid drops such as diesel oil; airborne solid particles; or another combustible mixture that burns rapidly enough to accomplish dynamic compression and detonation. The fuel is preferably mixed with a proportioned amount of air or oxidizer for complete combustion.

The igniter 4 is, for example, a conventional spark plug powered by a spark generator, glow-plug, piezo-electric spark gap or another suitable ignition device. In accordance with alternate embodiments of the invention, the igniter 4 is a hot plasma jet generated by a plasma jet generator (not shown) and directed into the ignition region of the hollow blast-forming chamber 3. Other fast and reliable devices for injecting flames or sparks essentially instantaneously into the ignition region are within the scope of the present invention as alternative ignition devices.

While the injector and igniter are preferably constructed such that they project through the outer housing 2 into the blast-forming chamber, either or both of the injector 5 and igniter 4 may be peripherally mounted in the inner charge forming housing 1 or in the space separating the inner and outer housings 1 and 2 (i.e., along the weld 6), so long as they extend into the ignition region of the hollow blast-forming chamber 3.

The combustible mixture injector 5 is any conventional injection system suitable for providing a controllable flow of the combustible mixture, including, for example, conventional fuel injectors and carburetors. Conventional carburetors used in conjunction with turbochargers allow the mixing of a wide variety of fuels with air for injection into the hollow blast-forming chamber 3.

The timing of the fuel injection and ignition, and therefore the timing of the combustion, is controlled by a control system (not shown) including fuel, air, and oxidizer valves. A valve port is formed at the combustible mixture injection point if a carburetor or pressurized bottled or liquid fuel is used to practice the invention. A valve for the valve port is operated to admit the combustible mixture into the hollow blast-forming chamber 3. The valve is a solenoid valve in each case, although other valves may be used, such as any of a rotary, disc, poppet or drum valve or any other device that allows air, oxidizer and fuel to be injected into the chamber 3 under positive pressure and that allows for a positive shutoff between induction cycles to accommodate the ignition cycle. If necessary, increased pressure from combustion in the hollow blast-forming chamber 3 operates over an area of the valve to close the valve and limit ignition injection into the carburetor.

The blast-forming chamber 3 includes only a single annular opening at the center. This opening comprises the area between the inner housing projection 7 and the outer housing 2. The substantially restrictive opening creates a restrictive pinch point that forms a primary or first stage compression area. A high-speed convergence or secondary compression zone 9 is created at the apex of the outer housing 2 generally at the center of the annular region defining the throat and substantially along the axis of the inner and outer housings 1 and 2.

General Operation of the Shaped Charge. The outer charge forming housing 2 is adapted to accept the introduction of a combustible mixture into the hollow blast-forming chamber 3 near the outer periphery of the base of the hollow blast-forming chamber 3. The blast-forming chamber is larger in cross-sectional area, at least relative to the throat, at the location of fuel injection and ignition. Because multiple fuel injectors 5 and igniters 4 are spaced along the periphery of the inner and outer charge forming housings 1 and 2, there are several locations within the chamber 3 at which combustion takes place. Preferably, combustion occurs at generally opposing sides of the chamber 3.

In an embodiment in which both air and oxidizers are both available, for example a combined jet/rocket engine, air is burned with fuel in sufficiently dense atmospheres to accommodate the fuel load while air is available. An air mass sensor (e.g., hot wire anomometry) or other sensor is coupled to a controller (not shown) that determines the amount of air available. The controller causes the inlet RAM port to open as air mass decreases so that sufficient oxygen enters the chamber 3. After the controller determines that air mass is too low, the air inlet stays open and the oxidizer port begins to open, causing oxidizer to enter the chamber 3. During the transitional period in which air is available but either not ideal or sufficient, both air and oxidizer are used. When the air density is too low, the outside air inlet closes and oxidizer alone is used for combustion. Thus, the device is operated aerobically in a jet mode, anaerobically in a rocket mode, or in any of combination of jet and rocket modes.

The igniters 4 and injectors 5 are located near the periphery of the blast-forming chamber 3, causing ignition to be started relatively near the periphery of the annular chamber 3. Because multiple igniters 4 are spaced around the chamber, ignition also takes place substantially simultaneously at several locations around the chamber. Each of the multiple injectors 5 simultaneously injects an appropriate amount of the combustible mixture into the chamber 3 under positive local pressure relative to the pressure inside the remainder of the hollow blast-forming chamber 3. The injector 5 is sealed or closed following the injection cycle, creating a barrier or block between the hollow blast-forming chamber 3 and the fuel and the air or oxidizer.

After sealing the injectors 5, each of the multiple igniters 4 essentially simultaneously ignites the charge of combustible mixture, causing the detonation (or pulse) along essentially the entire outer circumference of the base of the hollow blast-forming chamber 3. As the flame front or pulse advances toward the apex of the hollow blast-forming chamber 3, additional mass can be injected into the chamber 3 to increase the mass and therefore the momentum of the blast wave. Preferably, the injected mass is a safe mass such as water or an inert slurry, although the mass may alternatively be a combustible mass, including additional fuel. The explosion products are increasingly compressed by the gradual reduction in cross sectional area at the throat, or the apex of hollow blast-forming chamber 3. As the flame front advances toward the throat, primary or first stage compression is achieved by back pressure forcing the flame front essentially simultaneously into all areas of the throat. This forcing of the flame front through the throat creates a high-speed inwardly radial flow of explosion products toward the apex of the inner surface of the outer charge forming housing 2.

The high-speed explosion products stream exits the chamber through the throat and advances inwardly causing high-speed gases to converge near the inner surface 8 and at the center line 9 of the outer charge forming housing 2. The convergence creates, by the confluence of mass and kinetic energy, a secondary compression zone that forms the explosion products into hypersonic gases before their exhaustion in a controlled blast directed through the exhaust port. The resulting high pressure hypersonic exhaust E is expelled in a directed blast from the exhaust port without the need for an exit nozzle. The above description represents a single firing cycle, which is useful in many applications. The engine may alternatively be operated in a pulsed mode by repeating the above firing cycle.

The shaped charge engine is controllable using a throttle that may vary the fuel, air, and oxidizer volume. In a typical rotating disk valve that serves as a throttle, two holes are spaced 180 degrees apart to allow for injection of fuel only when the holes are aligned with the fuel lines as the disk rotates, for example at 100 RPM. As the disk rotation speed increases, the time moment of hole alignment decreases, providing a smaller amount of fuel to be injected per pulse. Conversely, decreasing the rotation rate will cause greater amounts of fuel to be injected per pulse.

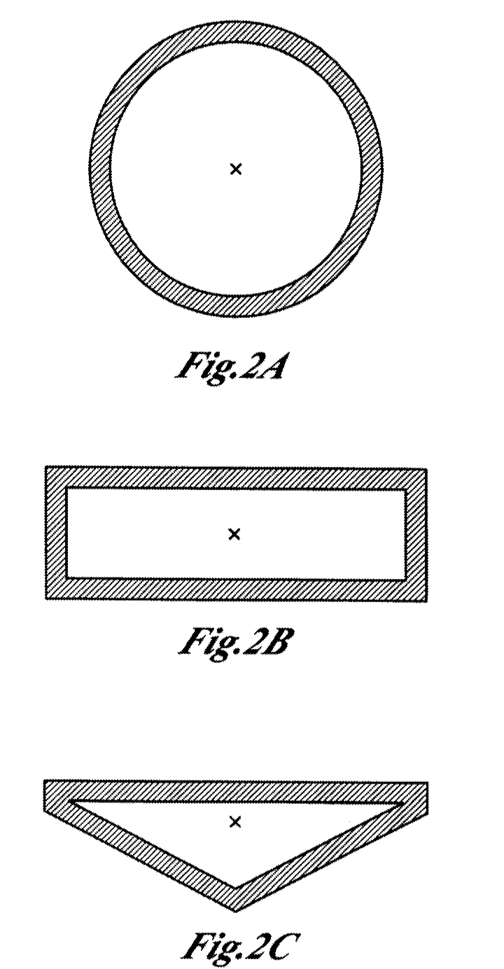

Alternate Embodiments of the Shaped Charge Engine. While the general construction and operation of the shaped charge engine of the preferred embodiment is discussed above and shown in FIG. 1, the construction may be varied, consistent with the present invention. In certain applications, it may be desirable to construct the shaped charge engine with an alternate geometric shape. For example, with reference to FIG. 2, the cross-sectional geometric shape may be varied in alternate embodiments. The generally circular or annular shape depicted in FIG. 2A corresponds to the circumference of the blast chamber 3 of the preferred embodiment shown in FIG. 1. Alternate embodiments are depicted in FIGS. 2B and 2C, showing rectangular and triangular designs, respectively.

The design of the preferred embodiment, shown in FIG. 2A, is an ideal shaped charge engine having exhaust products that converge at the center simultaneously. The rectangular embodiment of FIG. 2B is somewhat less efficient but still produces exhaust products that collide substantially simultaneously because exhaust products travel like distances from opposing sides before reaching the secondary compression zone. The triangular embodiment of FIG. 2C is quite inefficient, with uneven distances from the periphery of the combustion chamber 3 to the secondary compression region, producing lower exhaust velocities and less thrust than the circular embodiment of FIG. 2A. Still other shapes of a generally convex polygonal nature may be used, consistent with this invention.

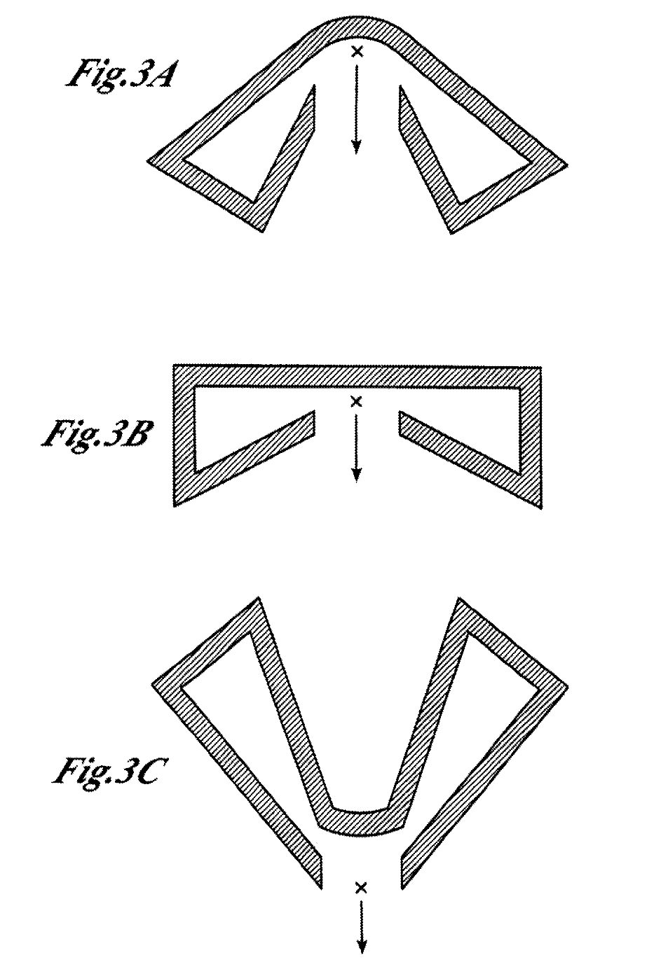

Just as the cross-sectional shape of the blast-forming chamber 3 may be varied, so may the orientation of the blast-forming chamber be altered. The general orientation of the preferred embodiment is depicted in FIG. 3A. In the embodiment of FIG. 3A (which may be characterized as “concave”), the exhaust products travel toward the throat from a point generally upstream of and somewhat orthogonal to the final exhaust direction. As the exhaust products pass through the throat, they collide with the outer housing 2 and gases emerging from opposite sides at the secondary compression zone, producing hypersonic exhaust in a direction somewhat opposite the direction of travel through the throat.

In an alternate embodiment, as depicted in FIG. 3B, the blast-forming chamber is substantially flat, so that the exhaust products travel through the throat in a direction generally orthogonal to the final exhaust direction. In yet another embodiment, as depicted in FIG. 3C, the blast-forming chamber is in a convex configuration, so that the exhaust products travel through the throat in a direction that forms an obtuse angle with the final exhaust direction. Likewise, additional orientations not depicted in FIG. 3 are possible.

Among the three embodiments depicted in FIG. 3, the embodiment of FIG. 3A can be considered a high pressure spike motor. The change in direction of the exhaust gases just beyond the throat causes “thermal stacking” of the gases just prior to exit. The result produces a powerful but brief spike of thrust as the gases exit the engine. While the total masses of exhaust products are the same in each embodiment, the thrust characteristics differ. Thus, the embodiment of FIG. 3B will produce a relatively weaker, longer thrust moment, while the embodiment of FIG. 3C will produce a more even exhaust flow with a relatively smaller spike.

Depending on the environment and desired performance, it may be useful to construct a single engine in which the blast chamber orientation can be dynamically varied from a convex orientation (such as in FIG. 3C) to a concave orientation (such as in FIG. 3A). In the preferred embodiment, particularly when used as a pulse jet/rocket engine as discussed further below with reference to FIG. 5, the shaped charge engine may be hinged and dynamically adjustable to create varying blast chamber orientations.

With reference again to FIGS. 3A-C, outer housing hinge points H1, H2 are indicated at locations that allow for adjustment of the orientation of the shaped charge engine. Thus, by pivoting the outer housing 2 at the location of the outer housing hinge points H1, H2, the orientation of the shaped charge engine may be changed along a continuum from a generally convex orientation (such as in FIG. 3C) to a concave orientation (such as in FIG. 3A). Because the blast chamber 3 is preferably a continuous annular ring, the inner and outer housings 1, 2 comprise a series of plates arranged to slide over and under one another as the configuration changes. Alternate constructions are also possible, including for example a combustion chamber that comprises a plurality of separate sub-chambers that are adjoining or nearly adjoining one another at the most concave and convex positions (as in FIGS. 3A AND 3C) but that are spaced relatively farther apart from one another in the more horizontal configurations as in FIG. 3B.

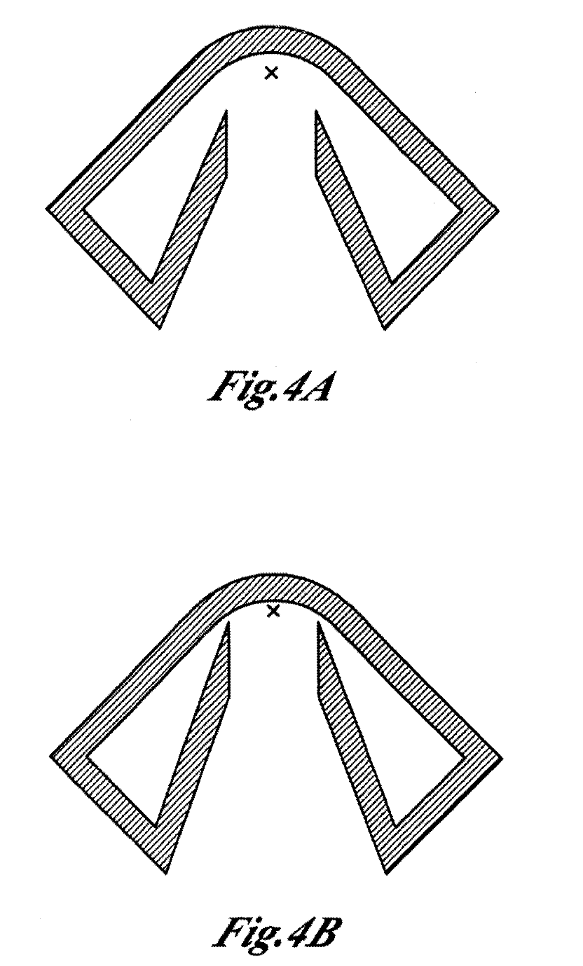

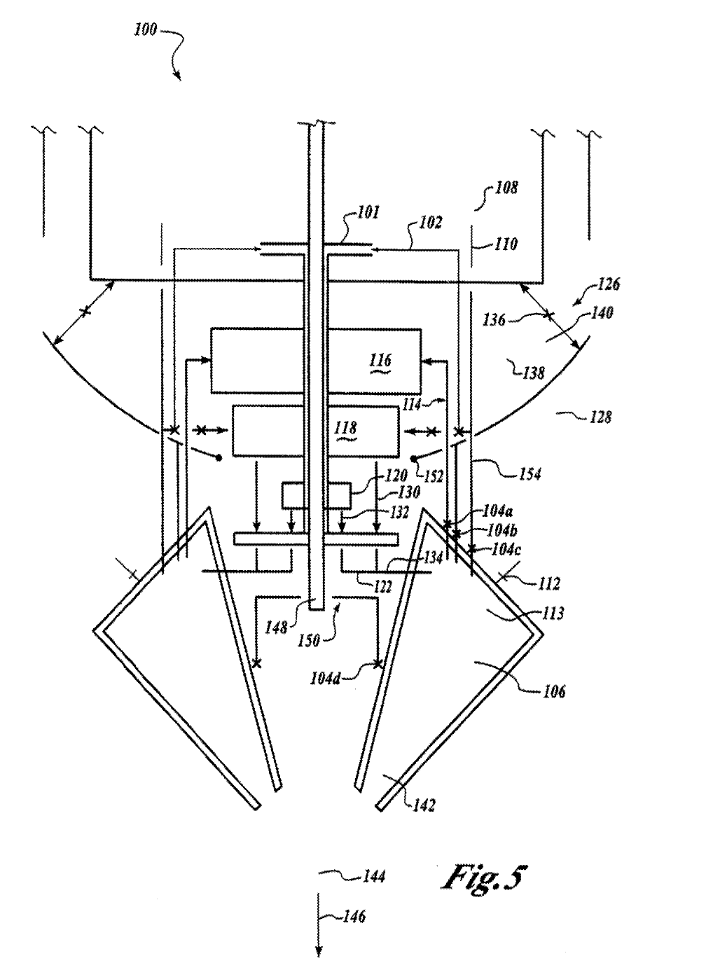

The throat area may also be varied, consistent with the invention. With reference to FIG. 4, two alternate embodiments are shown. In FIG. 4A, a low pressure engine is shown having a relatively larger throat. Alternatively, the embodiment of FIG. 4B includes a relatively smaller throat. Relative to the engine of FIG. 4B, the engine of FIG. 4A will create lower pressure in the combustion chamber 3, lower velocities through the throat, and a smaller spike in exhaust velocity and thrust.

Again with reference to FIGS. 3A-C, outer housing hinge points H3, H4 are indicated at positions that allow the inner housing 1 to be adjusted swing closer or farther from the outer housing 2. Thus, as the inner housing 1 is pivotally moved toward the outer housing 2, the size of the throat is decreased, producing a smaller “pinch point.” Conversely, the inner housing 1 can be rotated outward, away from the outer housing 2, producing a larger throat. In the case of both the adjusted orientation and adjusted throat area, the hinging action is best accomplished by hydraulics, screw-drive, or other such devices that can move metal plates and withstand the substantial pressures produced in the blast-forming chamber 3.

Use as a Switchable Pulsed Jet/Rocket Engine. A presently preferred application of the shaped charge engine is depicted in FIG. 5, which schematically illustrates a switchable pulsed jet/rocket engine. The switchable pulsed jet/rocket engine of FIG. 5, generally indicated by reference numeral 100, includes a shaped charge engine in accordance with that of FIG. 1, although it is shown in a concave orientation as in FIG. 3 C.

The engine begins operation from a cold start at low altitudes in a pulsed jet mode. Pulses of fuel and oxidizer are fed from sources of fuel 101 and oxidizer 108 to the shaped charge combustion chamber 106 via separate fuel and oxidizer lines 102, 110, each of which is controlled by a solenoid valve 104b, 104c. An igniter 112 ignites the fuel and oxidizer mixture, creating a blast and attendant high pressure within the chamber 106. When the rotary valve is in use (principally in jet mode), the igniter is controlled by a fixed timing ignition device such as, for example, points typically found in an automobile distributor, magneto or battery assisted magnetic pickups, or light sensitive relays. When direct fuel and oxidizer injection are used (in rocket mode), the igniter is controlled by computer processor initiated timing pulses.

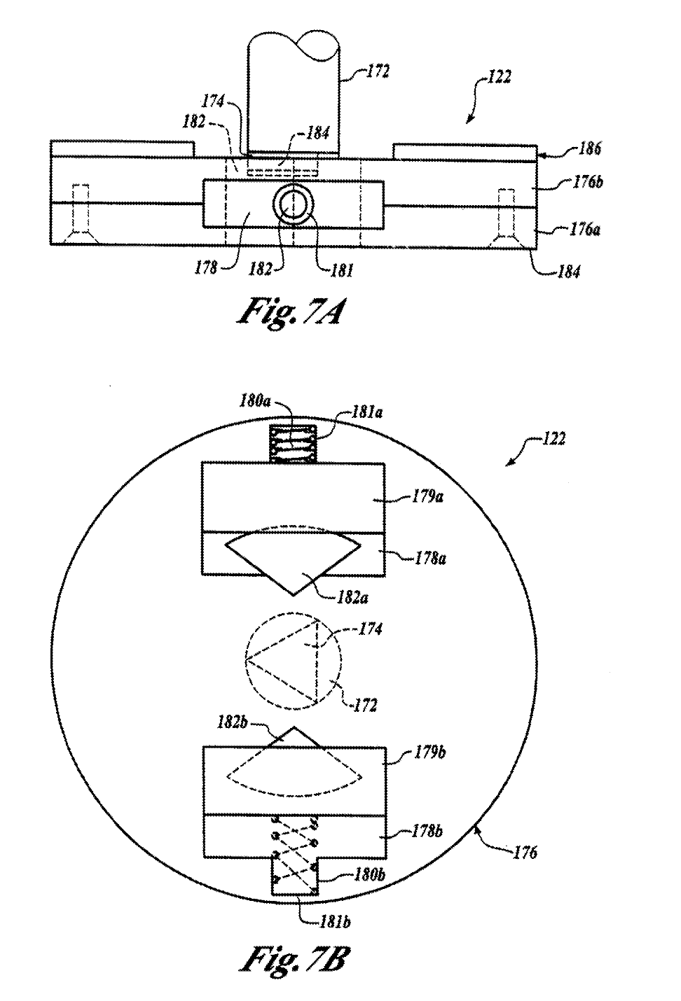

By opening a solenoid valve 104a on an exhaust bypass line 114, pressurized exhaust products are allowed to flow to an exhaust-driven turbine 116, causing it to rotate. The exhaust-driven turbine 116 is connected to a compressor 118, a fuel pump 120, and a centrifugal throttle valve 122, each of which is configured to rotate together as a unit. While an ordinary rotating disk may be used consistent with this invention, in the preferred embodiment the centrifugal throttle valve 122 (discussed in greater detail below with reference to FIG. 7) is used to provide superior control, particularly in fixed inlet pressure conditions. As the unit rotates, compressed air 126 collected via an air scoop 128 is delivered through an air line 130 while fuel is delivered via a fuel line 132 to the centrifugal throttle valve 122. The centrifugal throttle valve 122 allows air and fuel to pass through the valve by opening and closing multiple apertures that are cyclically aligned and misaligned as it rotates.

Fuel and air, after passing through the centrifugal throttle valve 122, are mixed in a mixing manifold 134 and injected into the shaped charge combustion chamber 106 when the centrifugal throttle valve 122 is opened. The centrifugal throttle valve 122 then closes and the igniter 112 ignites the fuel and air (or oxidizer) mixture within the chamber 106 at an ignition point 113. The detonation causes exhaust products to travel out the chamber 106.

The preferred centrifugal throttle valve is shown in side view in FIG. 7A and plan view in FIG. 7B. Previous rotary disk valves having fixed opening sizes such as are used in prior variable firing rate engines suffer many problems, regardless of the size or shape of the openings. For example, if the port is sized for low rate firing then the time during which the openings are aligned decreases as rotation increases, allowing less air, fuel, or mixture to pass through the valve per pulse. Consequently, higher inlet pressure is required to obtain the correct charge volume. On the other hand, if the port is sized for high rate firing, then at low firing rates the disk spins slower, the holes are aligned for longer periods, and an excess amount of air, fuel, or mixture is allowed to pass through the valve. In order to compensate for the excess and obtain the correct charge volume, lower inlet pressures and controls are required.

The rotary centrifugal throttle valve 122 overcomes these problems and allows for correct charge volumes at all firing rates while using a fixed inlet pressure. The centrifugal throttle valve 122 includes a driveshaft 172 having a projection 174 and a disk valve housing 176 mounted on the driveshaft 172. The disk valve housing 176 comprises two halves 176a, 176b joined together in conventional means such as welding, lamination, bolts, or screws 184. The two halves 176a, 176b of the disk valve housing 176 include recessions that, when the halves are joined, together form inner pockets 178a, 178b. The disk valve housing 176 also includes one or more openings 182a, 182b passing through the disk valve housing 176 substantially overlying the inner pockets. A sliding valve 179a, 179b is retained within each of the pockets 178a, 178b. A further recession within the two halves 176a, 176b of the disk valve housing forms spring pockets 181a, 181b that retain springs 180a, 180b associated with each sliding valve 179a, 179b. Other devices may be used in the place of the springs 180a, 180b to bias the sliding valves 179a, 179b in a closed position at slower rotation speeds, including other resilient materials or compression devices. Still further, the sliding valves 179a, 179b may be electronically controlled using hydraulics, worm-drives, or other mechanisms to open and close the valves as a function of rotation rate. While the centrifugal throttle valve 122 is illustrated as having two openings 182a, 182b, any number of openings may be used, consistent with the invention. Likewise, the openings 182a, 182b are illustrated as having a generally “pie” shape, but may be round, square, or any other shape.

With reference more particularly to FIG. 7B, the operation of the centrifugal throttle valve is illustrated, representationally both at high and low firing rates. At low firing rates, the disk valve housing 176 rotates at a relatively lower rate, causing the spring 180b to urge the sliding valve 179b in a direction radially inward within the pocket 178b. By moving toward the center of the disk valve housing 176, the sliding valve 179b covers a substantial portion of the opening 182b, limiting the amount of air, fuel, or mixture that may pass through to the combustion chamber. Note that the openings 182a, 182b are preferably formed so that the sliding valves 178a, 178b cannot fully cover them even when the centrifugal throttle valve 122 is stopped or at its slowest rate of rotation. This arrangement allows air, fuel, or mixture to reach the combustion chamber during start-up and prevents the engine from stalling at the lowest firing rates.

At relatively higher firing rates, centrifugal forces cause the sliding valve 179a to compress the spring 180a farther within the spring housing 181a. The recession of the spring radially outwardly uncovers a substantial portion of the opening 182a, allowing a greater amount of fuel, air, or mixture to pass through to the combustion chamber. In any particular application, the throttle valve may be tailored by substituting springs of greater or lesser resistance, altering the opening size or shape, locating the openings farther inward or outward along the disk housing radius, or increasing or decreasing the number of openings on the disk valve housing 176.

While the above discussion and illustration in FIG. 7B depicts one opening 182a substantially uncovered by the sliding valve 179a as would be the case at a high firing rate, and one opening 182b substantially covered by the sliding valve 179b as would be the case at a low firing rate, this condition is shown on a single valve only for ease of illustration and discussion. In practice, each of the openings 182a, 182b would be covered or uncovered by the sliding valves 179a, 179b to substantially the same extent at all times.

The projection 174 on the driveshaft 172 is shown as a triangle shape, offset from the center of the driveshaft 172. The projection 174 may alternatively be of any shape, although an irregular shape is preferred to prevent joining the driveshaft 172 to the disk housing 176 out of phase with ignition or other external parts that require timing. The driveshaft 172 is joined to the disk housing 176 by inserting the projection 174 into a similarly shaped recession 184 within the disk housing 176. The projection 174 and recession 184 are configured to allow the projection 174 to slide within the recession 184, permitting the disk housing 176 to move inward or outward along the shaft 172. A thrust washer 186 absorbs the force imparted on the disk housing 176 and ensures a tight seal. This construction allows the centrifugal throttle valve to absorb substantial pressures without damaging the drive motor or other components. Moreover, the sliding arrangement of the projection 174 within the recession 184 allows for wear on the thrust washer.

As the turbine 116, compressor 118, fuel pump 120, and centrifugal throttle valve 122 continue to rotate, pulses of the fuel and air mixture are continually produced and ignited as described above. The solenoid valve 104c associated with the exhaust bypass line 114 is modulated (or pulsed) to produce the desired idle speed of the turbine and the engine itself.

The air scoop 128 is opened or closed automatically via a linear actuator 136. The linear actuator 136 is controlled by an air mass sensor 138 that, as discussed above, determines the air mass available. In the preferred embodiment, the air mass sensor 138 essentially comprises a heated wire that decreases in temperature as increased air mass flows over the wire during flight. The temperature of the wire is read by a processor (not shown) to determine the magnitude of the existing air mass. Thus, the linear actuator 136 can, for example, open the air scoop 128 when the air mass sensor 138 senses a reduced air mass available, causing more air volume to enter the intake air plenum 140.

With the engine at idle, the switchable pulsed jet/rocket is ready to transition to a pulse jet mode of operation in which substantial thrust is produced. The solenoid valve 104c on the exhaust bypass line 114 is opened substantially fully, allowing more exhaust gas to flow through the line to drive the turbine 116, causing it to rotate faster. In turn, the compressor 118, fuel pump 120, and centrifugal throttle valve 122 rotate faster. Because of the centrifugal forces produced by the faster rotation, the centrifugal throttle valve 122 automatically opens the valve aperture opening to allow higher air and fuel flows required at rapid pulse rates.

The high pulse rate fuel and air charges that are ignited by the timed ignition of the igniter 112 causes detonation wave exhaust streams to flow from the ignition point 113 within the combustion chamber 106. The exhaust streams flow through the low pressure pinch point at the throat 142 and converge at a secondary high pressure compression point 144 from which they exit as a high pressure hypersonic exhaust flow in the direction of the arrow 146. The engine is now operating at the highest thrust setting possible using air and fuel as the inertial mass (and without altering the shape or orientation of the combustion chamber 106).

Greater thrust can be obtained by adding additional mass to the combustion chamber 106. As noted previously, the additional mass is preferably a safe mass such as water or an inert slurry. The additional mass products from the mass injection manifold 148 are injected into the chamber 106 by opening a solenoid valve 104d located on an additional mass line 150. The additional mass is injected into the chamber 106 between pulses and prior to firing of the igniter 112. The exhaust stream automatically accelerates the additional mass out the chamber 106. The engine is now at an ultra-high thrust setting; that is, the maximum thrust that can be achieved using fuel, any combination of air and oxidizer, and added mass to produce thrust in the configuration and orientation of the engine.

As the atmosphere thins, the pressure in the air intake plenum 140 diminishes and is sensed by the air mass sensor 138. The air scoop 128 is automatically opened by extending the linear actuator 136, causing the air scoop 128 to pivot on a hinge point 152. The additional volume of air increases the pressure in the plenum 140 to satisfy the oxygen requirements of the engine until the air scoop 128 is opened to its widest position. As the atmosphere thins further, the air scoop cannot admit a greater flow of air. A computer controller (not shown) coupled to the air mass sensor 138, upon determining that the air scoop 128 is open at its widest and the air is too thin, causes one or more oxidizer valves 154 to open to allow oxidizer to flow into the chamber 106. While the oxidizer valves 154 are preferably driven by a controller containing a processor, they may alternatively be driven directly by proximity switches associated with the air mass sensor 138 and linear actuator 136. The oxidizer valve 154 allows an increasing amount of oxidizer to be injected into the blast chamber 106 as the atmosphere thins even further.

When no air or atmospheric pressure is sensed by the air mass sensor 138, the engine operates in an anaerobic mode essentially as a space vehicle. The solenoid valve 104c on the exhaust bypass line 114 closes, causing the turbine 116, compressor 118, fuel pump 120, and centrifugal throttle valve 122 to stop rotating. Likewise, because there is no air available, the air intake scoop 128 is closed by retracting the linear actuator 136.

Fuel and oxidizer are fed directly to the combustion chamber 106 via the fuel line 102 and oxidizer line 110 by timed pulses of the solenoid valves 104 a, b. All other operations of the ignition, injection of mass, and exhaust are the same as in the air-breathing mode of operation.

When air becomes available as the engine descends, the air mass sensor 138 detects the increased presence of air and allows the air scoop 128 to open so that an aerobic, or jet, mode of operation can again take place.

Hinged and gimbaled operations. In the preferred embodiment of the present invention, the shaped charge engine is hinged so that the orientation of the combustion chambers can be dynamically altered during flight. Such a construction is discussed above with reference to FIGS. 3A-C.

In addition, the engine can be gimbaled to allow the direction of the exhaust products to be controlled. The outer engine is pivotally mounted on the air/space craft so that the exhaust stream can be directed. By pivoting the engine, and therefore the exhaust stream, the engine itself provides directional control. In alternate embodiments, the blast-forming chamber 3 may be pivotally mounted while the remainder of the propulsion and control system is fixed. In still another alternate embodiment, directional control can be obtained by adjusting the inner and outer housing hinges H1, H2, H3, H4 in an asymmetrical fashion. Thus, for example, the outer housing hinges H1, H2 can be adjusted to produce a blast-forming chamber having opposing sides that are in slightly different orientations. Likewise, for example, the inner housing hinges H3, H4 can be adjusted to produce a throat that is imbalanced on opposing sides. In either configuration, the exhaust stream will be directed off-center, providing directional control.

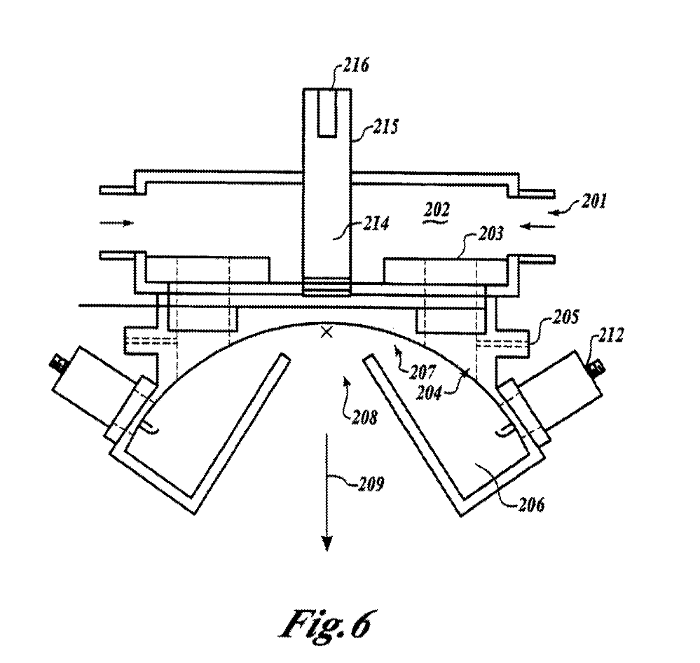

Use as a Pulse Driver for Other Vehicles. While the shaped charge engine of this invention is described above as suitable for air-breathing and non-air-breathing applications, it can also be adapted for use in applications that always have air available. For example, the shaped charge engine may propel a car or boat, may be used in a tool or as a generator, or may be used in many other applications that will have air available. The general construction of the shaped charge engine for use in such atmospheric conditions is shown in FIG. 6. The atmospheric engine includes one or more air intake ports 201 leading to a compressor 202. The compressed air is passed through air outlet ports 203 to the combustion chamber 206 via engine air inlet ports 204. Fuel from a fuel source (not shown) is injected via fuel injectors 205.

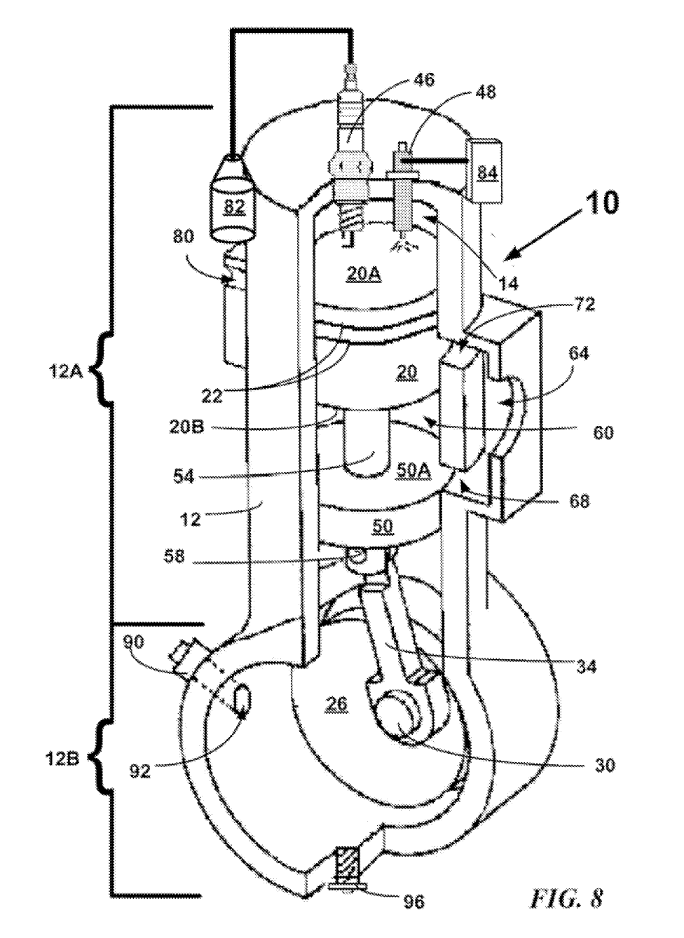

In the same manner as discussed above, the engine includes a primary low pressure pinch point at the throat 207 leading to a secondary high compression point 208 that produces a high pressure exhaust stream 209. The fuel and air mixture is ignited by an igniter 212 that is illustrated as a spark plug. A drive motor (not shown) is connected to a drive shaft 215 via a key way or spline 216. In turn, a valve drive extension 214 on the drive shaft 215 is connected to a rotary centrifugal throttle valve that operates as described above with reference to FIG. 8.

The primary difference between the shaped charge engine of FIG. 6 and the pulsed jet/rocket engine of FIG. 5 is the inclusion of oxidizer and the ability to open and close air intake scoops. In all other relevant respects, the engines of FIGS. 5 and 6 are constructed and operate in a similar manner.

Use as a Turbine Driver. The shaped charge engine has been described above as a direct propulsion device. Alternatively, the high compression, high inertia exhaust stream can drive fixed cycle or free spinning turbines such as those of the Pelton or axial flow type. One example of a detonation cycle turbine engine is shown in U.S. Pat. No. 6,000,214 to Scragg. Scragg discloses a turbine rotor driven by the exhaust ports of two combustion chambers on opposite sides of the rotor. The torque produced by the acceleration and rotation of the turbine is put to work in conventional electrical or mechanical means.

Similarly, the exhaust of a single or any number of shaped charge engines can be directed toward a turbine. Because the shaped charge engine of the present invention is far more efficient, however, it produces a much improved turbine-driving engine.

Other Uses of the Shaped Charge. As discussed above, the shaped charge engine may be used to propel an aircraft, preferably including an aircraft that may travel in both atmospheric conditions, space conditions, or both. Further, the engine may be used as a direct exhaust drive to propel a personal watercraft, boat, or other vehicle, or may be configured to drive a turbine to propel a car, boat, motorcycle, or other vehicles. In addition, the engine may be used as a bow thruster for boats, ships, or submarines.

In addition to propelling vehicles, the blast or pulse produced by the shaped charge engine is useful in a host of other applications. For example, the shock waves produced by the engine can be used for underground rodent and pest extermination or the control of insects. The shock wave from a single pulse may be used in avalanche control to initiate movement of the potential avalanche, eliminating the need for artillery or explosives.

The shaped charge may also be used for a variety of demolition purposes. For example, it may be used as a rock breaker, to demolish buildings, to fracture rocks in mining, to core and break concrete, or to remove ice from ships, bridges, or roads. In addition, the shaped charge may have military uses as a mine that is both powerful and reusable. Ideally, the material is fragmented by directing one or more shock waves toward it. Moreover, the demolition devices constructed using the present shaped charge invention may be recovered and reused, unlike conventional demolition devices.

A wide range of tools may be created using the shaped charge engine of the present invention. For example, the enormous shock waves produced may be put to use as a jackhammer or other impact tool, or may be focused to produce cutting and etching devices. Hot paint, foam, or metal may be sprayed in an alternate embodiment of the present invention in which paint, foam, or metal is used as the additional mass injected into the blast chamber after ignition. Precisely focused and directed shaped charges may also be used in tree limb removal or weed trimming. Still further, the hot, powerful blasts may be put to use as a burner (such as in a furnace or boiler) or to remove snow from driveways, rooftops, or other locations. Moreover, hot, high pressure exhaust gases may be used to strip paint, varnish, and similar coatings.

In still further applications, a single pulse creates instant heat and pressure for differential pressure forming of metal without the necessity of pre-heating the metal and without requiring compressors or other pressure storage devices. Similarly, pulses may be used to form materials by direct injection devices.

By placing projectiles in the exhaust stream, the shaped charge engine can be used as a high-speed gun. Preferably, a gun barrel or similar launch tube extends from the exhaust port so that the exhaust stream will propel the projectile in a controllable, straight path.

In a closed system, the shaped charge engine may be used to create and maintain pressure, adjusting the magnitude and rate of pulsing to control the pressure. Alternatively, when configured to drive a turbine, the shaped charge engine may form a generator to produce electricity.

Results from Actual Embodiments. As discussed above, serial infusion and ignition of multiple charges of combustible mixture into the hollow blast-forming chamber allow the detonation to be formed in a pulsed manner. The pulse strength and/or frequency is dynamically controlled during operation by varying the quantity and rate of infusing and igniting the serial charges of combustible mixture. Tests of an actual embodiment using the pulsed operation of the hypersonic exhaust stream indicate that operating cycles over 100 Hz and exhaust gas velocities as high as 30,000 feet per second are possible. Thus, independent variation is possible between gentle and powerful pulses and between slow and fast pulse.

As a pulsed jet or rocket engine for aerial vehicles, exhaust gas speeds higher than possible with conventional turbine or rocket propulsion units allow for smaller, lighter drives with fewer moving parts while potentially eliminating turbine blades, compressors, and exhaust nozzles. The pulsed hypersonic exhaust stream also reduces engine cooling requirements by providing pulsed rather than continuous operation. The rapid burning and detonation assist in engine cooling by converting the chemical energy of the combustible mixture quickly into high pressure with little wasted heat. This complete combustion also allows a higher efficiency of the engine and lower fuel use per pound of thrust produced.

An actual embodiment of the present invention has been constructed and tested against a variety of other engines, demonstrating the superior results. An engine capable of delivering 200 horse power (hp) constructed according to U.S. Pat. No. 6,000,214 to Scragg weighs approximately 262 pounds and can produce 0.76 hp per pound of engine weight. An actual embodiment of the present invention that can deliver more than 200 hp weighs only 70 pounds and produces 2.86 hp/pound. The shaped charge engine is also many times smaller, having a combustion chamber of 18 cubic inches compared with 560 cubic inches in a Scragg engine.

The advantages over gasoline, diesel, and Brayton cycle engines are also substantial. In comparison to the actual 200 hp embodiment discussed above, equivalent 200 hp gasoline, diesel, and Brayton engines can produce only 0.40, 0.22, and 1.0 hp/pound, respectively, and weigh approximately 500, 900, and 200 pounds. Consequently, an engine according to the present invention produces significantly more power at a much smaller size and weight than previous engines.

General Construction of the two-cycle engine. FIG. 8 is a cross-sectional isometric view of an oil-less fuel-injected two-cycle engine 10. The two-cycle engine 10 includes a housing 12, the housing 12 defining a substantially cylindrically shaped combustion cylinder 12A and a substantially cylindrically shaped crankcase 12B.

The crankcase 12B is disposed approximately 90 degrees to the combustion chamber 12A. In slidable and sealable contact with the internal walls of the combustion cylinder 12A is a piston 20. The piston 20 has two lateral surfaces or sides, a piston topside 20A and a piston bottom side 20B. The cylinder side of the piston 20 is fitted with piston rings 22. Located at the top of the combustion cylinder 12A is a combustion chamber 14, the volume of which depends on the movement extremes of the piston 20. Fitted to the combustion chamber 14 is an ignition source 46, such as a spark plug, and a fuel injector or atomizer 48 connected with a fuel supply.

The crankcase chamber 12B houses the components needed to convert the reciprocating linear motion of the piston 20 into rotary motion, the components including a crankshaft disc 26, a crankshaft pin 30 attached off center to the crankshaft disc 26, and a piston rod 34 attached to the crankshaft pin 30. Interposed between the piston 20 and the crankcase chamber 12B, is a crankcase divider 50. The upper surface of the crankcase 50 is a divider topside 50A that faces the piston bottom side 50B. The crankcase divider 50 is stationary and has an aperture (not shown) that is in slidable and sealable contact with a piston extension rod 54. The piston extension rod 54 connects to the piston rod 34 through a wrist pin 58, and to the piston 20 through a connecting pin such as the wrist pin 58. Alternatively, the piston 20 may welded or bolted to the piston extension rod 54. The piston extension rod 54 moves through the aperture of the crankcase divider 50 within the movement limit extremes imposed to the piston 20 by rotation limits of the crankshaft pin 30.

Between the piston 20 and the top of the crankcase divider 50, is an air charge intake space 60 having a variable volume depending on the reciprocating movement extremes of the piston 20. That is, the volume of the intake space 60 varies with the distance between the piston bottom side 20B and the divider topside 50A. In fluid communication with the combustion chamber 14 and the air intake space 60 is an air port 64, an air intake chamber sleeve port 68, and a compression chamber inlet sleeve port 72. Attached with the air port 64 is an air filter 98 to provide filtered air to the two-cycle engine 10. Between the air port 60 and the filter 98 is a reed valve 84. Filtered air enters the air port 64 when the reed valve 84 is in the open position caused by exposure to negative pressure created in the air space 60.

The spark plug 46 receives a high voltage surge from an ignition coil 82. The ignition coil 82 and the fuel injector 46 are in signal communication with a timing circuit 84. The timing circuit 84 is configured to determine the location of the piston 20 from signal inputs received by one or more sensors measuring the location of the piston 20, the piston rod 34, the piston extension rod 54, the crankshaft pin 30, or the crankshaft disc 26. The timing of ignition and fuel injection is determined by the timing circuit 84 upon the timing circuit's assessment of the location of the piston 20.

The design of the sleeve ports 72 and 80 are slot like, such that when the piston 20 is in a fully upwards position, the sleeve ports 72 and 80 are completed masked or blocked by the cylinder side of the piston 20, where the piston rings 22 engage against the vertical wall of the chamber 14, preventing fluid communication with the chamber 14. Similarly, when the piston 20 is in a fully downward position, the sleeve ports 72 and 80 are completed unmasked or unblocked, establishing fluid communication with the chamber 14. The piston 20 has a top or first surface 20A and a bottom or second surface 20B. The cylinder side of the piston 20 is slidably and sealably engaged against the walls of the combustion and air intake chambers 14 and 60 by oil lubricated piston rings 22.

The top surface 20A compresses air-fuel charges delivered to and expels exhaust from the combustion chamber 14. The bottom lateral surface 20B draws in air charges from the inlet port 72 and compresses the air charge against the divider top surface 50A of the crankcase divider 50 for delivery to the combustion chamber 14. The volume of charge chamber 60 is maximal when compression cylinder 14 is at top dead center (TDC) and is minimal when the piston 20 is at bottom dead center (BDC).

The charge chamber 60 receives the air charges transferred by the unmasking of the air chamber sleeve port 68 that is exposed to a vacuum or suction force when the piston 20 travels upwards towards TDC (and is the furthest distance from the crankcase divider 50). As the piston 20 moves toward BDC (the position nearest to the crankcase divider 50), the air charge is pressurized and the reed valve 84 closes and obstructs the air port 64. The pressurized air-charge inside the collapsing air space 60 is transferred to the combustion chamber 14 by the unmasking of the inlet sleeve port 72 in fluid communication with the combustion chamber 14. The pressurized air charge enters the combustion chamber 14 and displaces or sweeps out the residual combustion gases from the previous ignition to and through the exhaust port 80. A portion of the pressurized, incoming air-charge is short circuited to the exhaust port 80 while the residual combustion gases are being displaced. The piston 20 continues its movement toward TDC and masks or seals the inlet sleeveport 72 and exhaust sleeveport 80. After ports 72 and 80 are effectively closed by the occluding action of the cylinder side of the piston 20, the fuel injector 48 is activated by the timing circuit 84 and delivers oil-less aerosolized fuel to the chamber 14 to form an oil-less air-fuel mixture. Because the exhaust port 80 is closed via occlusion of the side of the piston 20 before the oil-less fuel is injected into the chamber 14, there is no fuel short-circuiting to the exhaust port 80.

At approximately TDC, the timing circuit 84 causes the ignition coil 82 to deliver a high voltage current to the spark plug 46 and ignite the oil-less air-fuel charge in the combustion chamber 14. After ignition, combustion products are exhausted through an exhaust sleeve port 80 that is unmasked while the piston 20 moves downwards during a power stroke. The design of the sleeve port 80 is slot like, such that when the piston 20 is in a fully upward position, the sleeve port 80 is completed masked or blocked by the cylinder side of the piston 20, preventing fluid communication to the outside. Similarly, when the piston 20 is in a fully downwards position, the sleeve port 80 is completed unmasked or unblocked, establishing fluid communication to the outside.

The crankshaft chamber 12B, being separated from air-fuel charges by the crankcase divider 50, is able to have direct oil lubrication via a lubrication port 90 that is in fluid communication with a crankcase aperture 92. Oil is poured through the lubrication port 90 and enters the crankcase chamber 12B through the crankcase aperture 92. Oil is removed from the crankcase chamber 12B via a plug 96. Alternatively, the oil can be removed by tilting the engine 10 to cause flow reversal through the crankcase aperture 92 and the lubrication port 90. This embodiment is well suited for lightweight, small engines amenable to tilting for draining oil through the lubrication port 90, which wouldn't require the plug 96 for removing spent oil.

Other embodiments of the engine 10 are built using self-lubricating materials to supply, optionally, a lubrication reservoir in the crankshaft chamber, or alternatively, the use of sealed oil lubricated bearing and race assemblies.

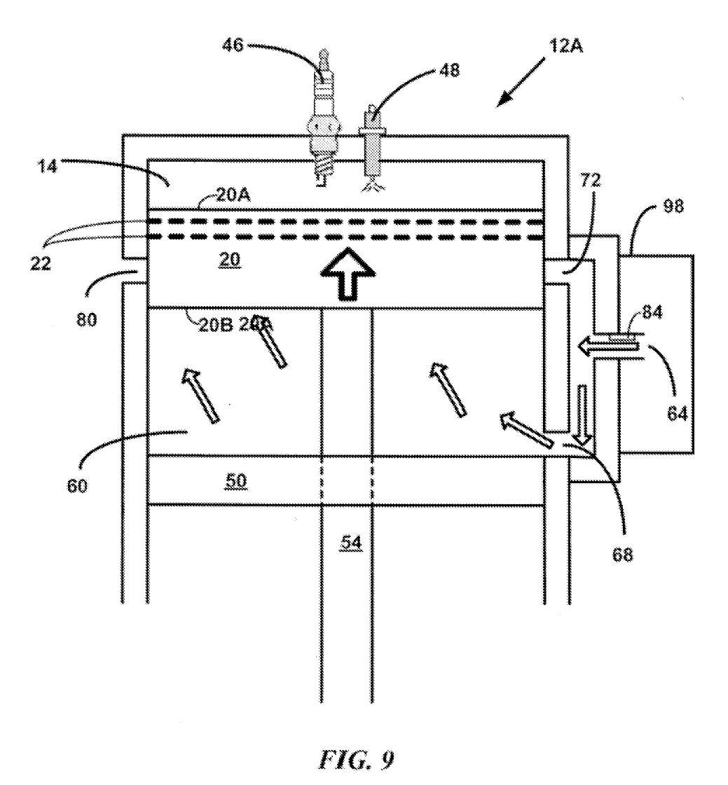

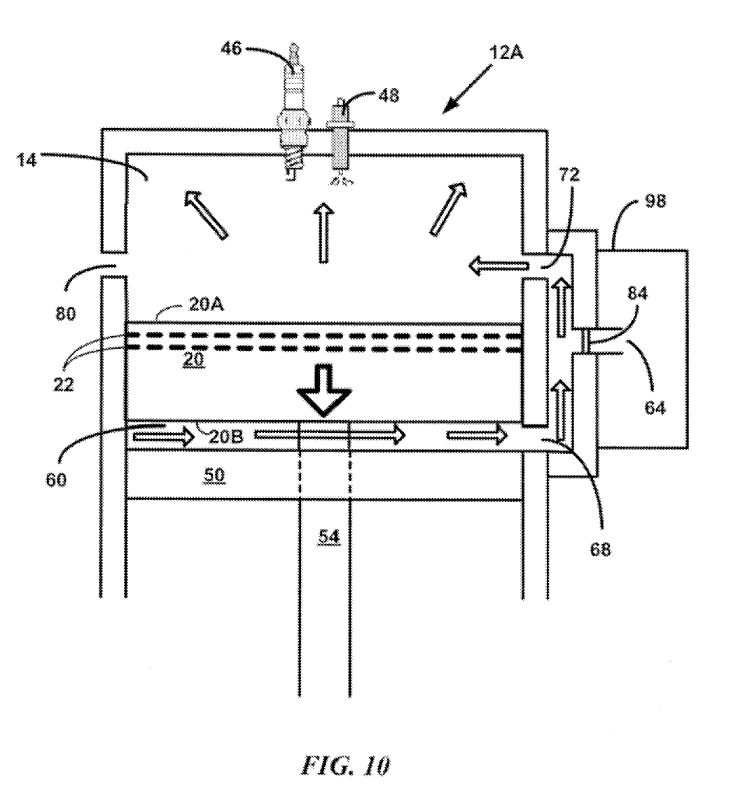

General Operation of the two-cycle engine. FIGS. 9 and 10 are schematic illustrations of the fuel-injected two-cycle engine 10 and demonstrate the general functional design and operation of the engine components. Other configurations of the fuel injected two-cycle engine 10 are possible.

FIG. 9 illustrates the combustion cylinder member 12A in cross-sectional view during the compression stroke and the flow of air-fuel charge into the air chamber 60 when the piston 20 is at or approaching TDC and creates a suction force or vacuum. Air charges flow from the carburetor port 64 through a reed valve 84 in the open position, and through the channel connecting the air-fuel chamber sleeve port 68 into the air chamber 60 defined now by the maximal space conferred at TDC between the piston 20 and crankcase divider 50. The reed valve 84 is configured to operate in the open position when the air pressure in the air chamber 60 is less than the air pressure near the air port 64. Sleeve ports 72 and 80 remain masked as the volume of compression chamber 14 is minimal at TDC for ignition of a compressed air-fuel mixture by the ignition source 46. The piston extension rod 54 slidably and sealably moves through the aperture of the crankcase divider 50.

FIG. 10 illustrates the combustion cylinder member 12A in cross-sectional view during the power stroke and the flow of air charge into the compression chamber 14 when the piston 20 is at or approaching BDC and creates a pressure force. Air charges flow from the air chamber 60 through unmasked sleeve ports 68 and 72 to the compression chamber 14 now at maximal volume between the piston 20 and the crankcase divider 50. The reed valve 84 near air port 64 is closed to prevent backflow through the air port 64. The reed valve 84 is configured to operate in the closed position when the air pressure in the air chamber 60 is greater than the air pressure near the air port 64. The incoming air charge displaces the combusted products from the combustion chamber 14 through the unmasking of the exhaust sleeve port 80. A portion of the incoming air charge is short circuited to the exhaust port 80 during the exhausting of spent combustion gases. Sleeve ports 72 and 68 remain unmasked and open as incoming air charges fills into the compression chamber 14 now expanded and ready for the next compression and ignition cycle. The piston 20 continues its upward movement with the sides of the piston blocking or masking (sealing) the inlet and exhaust ports 72 and 80. Oil-less fuel is delivered by the fuel injector 48 as an atomized form while the top surface 20A approaches TDC. The atomized fuel mixes with the remaining air in the chamber 14 that was not short circuited, forming an oil-less air-fuel mixture. The oil-less air-fuel mixture not short circuited is pressurized and ignited by the spark plug 46 when the piston 20 approaches TDC. Near TDC the inlet and exhaust sleeve ports 72 and 80 are covered or blocked by the sides of the piston 20 that make sealing contact with the sides of the chamber 14. At ignition, expanding and pressured combustion gases drive the piston 20 downwards to pressurize and deliver another air charge to the chamber 14 and exhausting the spent combustion gases. During this reciprocating cycle, the piston extension rod 54 slidably and sealably moves through the aperture of the crankcase divider 50.

Alternate Embodiments of the two-cycle engine. While the general construction and operation of the two-cycle engine of the preferred embodiment is discussed above and shown in FIGS. 8-10, the construction may be varied, consistent with the present invention. In certain applications, it may be desirable to construct the two-cycle engine with removable wrist pins similar to the wrist pin 58 but fitted with a sealed pre-lubricated ball or roller bearing so that the crankcase components are lubricated without an active oil-lubrication system. Similarly, the piston rings of the piston 20 may be made of self-lubricating materials to avoid the necessity of an active lubrication system.

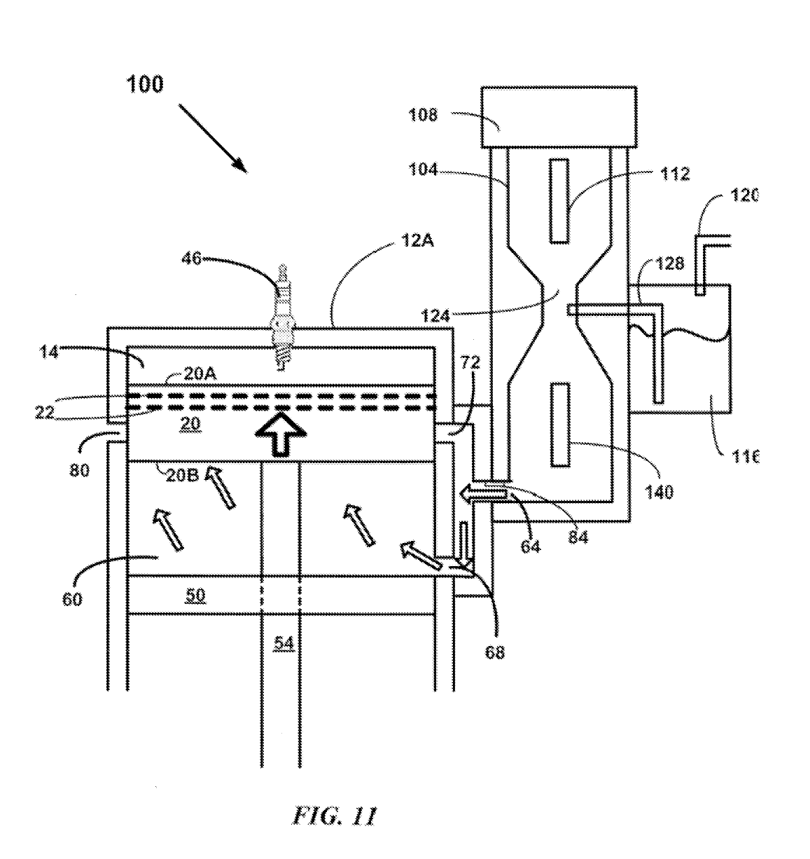

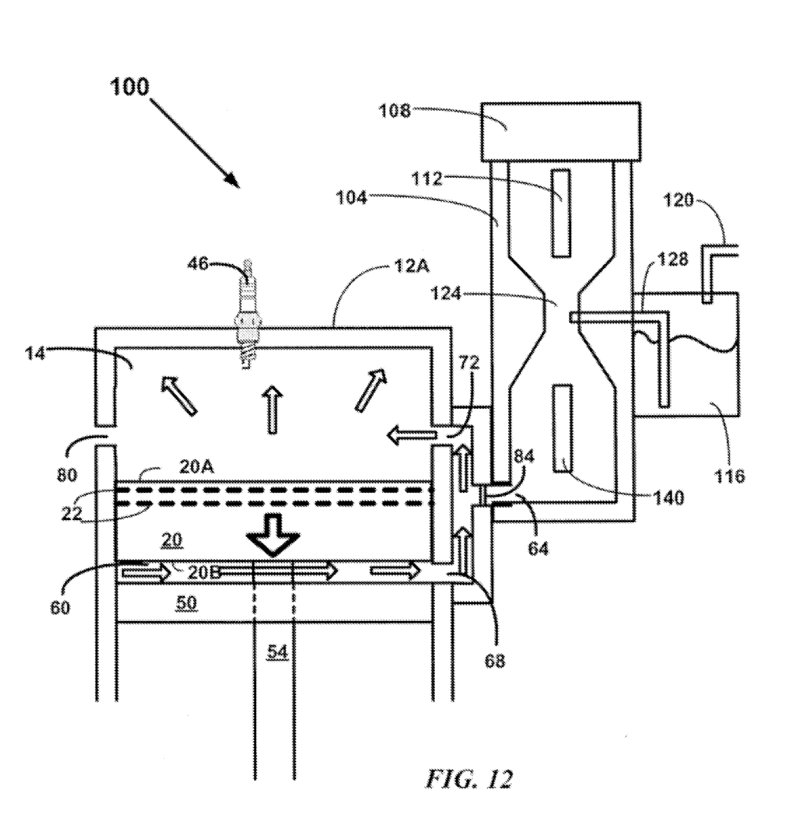

Another alternate embodiment of the two-cycle engine uses oil-less fuels that are premixed with air by an attached carburetor that routes the oil-less air-fuel charge made by the carburetor to the air space 60 for subsequent pressurization and delivery to the combustion chamber 14 not fitted with a fuel injector. As there is some air-fuel exhaust port short-circuiting, fuel economy in the alternate embodiment is realized primarily by the use of oil-less fuels. FIGS. 11 and 12 are schematic illustrations of a carbureted two-cycle engine 100 and demonstrate the general functional design and operation of the engine components. Other configurations of the carbureted two-cycle engine 100 are possible.

FIG. 11 is a cross-sectional view of the combustion chamber and air intake space when the piston is at top dead center in the carbureted two-cycle engine 100. The air intake space 60 is in fluid communication with a carburetor 104 via the air port 64. The carburetor 104 includes a carburetor filter 108 to filter incoming air, a choke valve 112 to regulate the amount of air through the carburetor 104, a fuel reservoir 116 with an inlet fuel line 120, and a constricted space 124 in fluid contact with an outlet venturi fuel line 128 that in turn is in fluid contact with the fuel reservoir 116. Beneath the constricted space 124 is a throttle valve 140 that regulates the amount of oil-less fuel that enter the constricted space 124 from the venturi 128. At the restricted space 124 oil-less fuel from the venturi is aerosolized. Upon receiving negative pressure from the upward movement of piston 20 toward the combustion chamber 14, the reed valve 84 is opened and the aerosolized air-fuel charge from the carburetor is routed to the air space 60 via the air port 64 and inlet sleeve port 72.

FIG. 12 is a cross-sectional view of the combustion chamber and air intake space when the piston is at bottom dead center in the carbureted two-cycle engine 100. The air-fuel intake charge is pressurized on the downward stroke of the piston 20, where the bottom surface 20B routes the air-fuel charge to the combustion chamber 14 via inlet sleeve port 72. Combustion gases from the previous cycle are displaced through the exhaust port 80. A portion of the incoming air-fuel mixture is short circuited to the exhaust port 80. The remaining oil-less air-fuel mixture not short circuited is ignited by the spark plug 46 near TDC while the inlet and exhaust sleeve ports 72 and 80 are covered or blocked by the sides of the piston 20. In this embodiment, the combustion chamber does not have a fuel injector or atomizer 48. Similarly, the crankcase and combustion chamber components can be directly oil lubricated, or equipped with sealed lubricated fittings or made from self-lubricating materials.

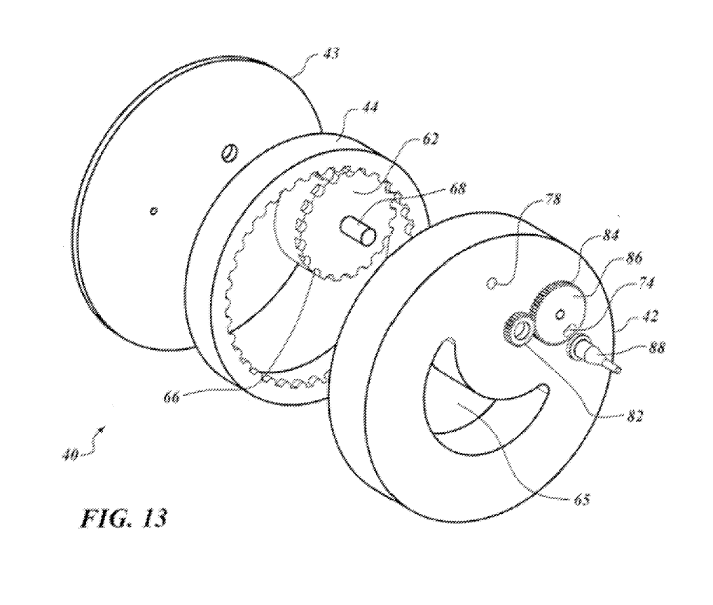

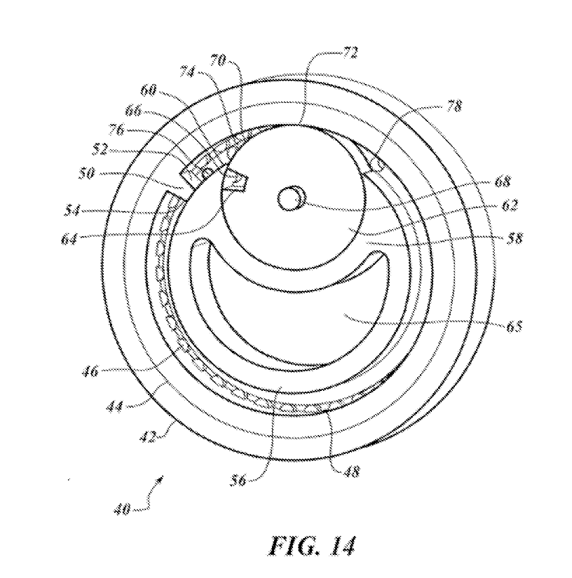

FIG. 13 depicts a preferred embodiment of a rotary machine 40. The rotary machine 40 employs a generally toroidal-shaped housing 42 having a cover 43 at one end. Disposed substantially within the toroidal housing 42 and integrally connected to the housing 42 is a plurality of rotary components. The generally toroidal-shaped housing 42 is substantially cylindrical in shape at its perimeter. However, at an end of the housing 42 opposite of the cover 43, the housing forms a generally toroidal inner housing 56 (see FIG. 14).

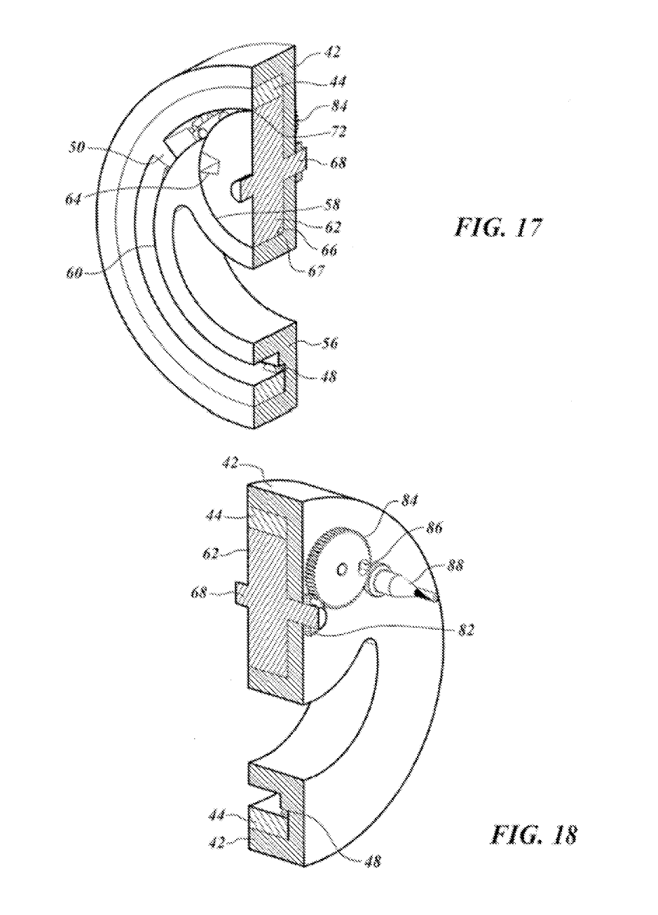

An expansion ring 44 is located within the housing 42 and the cover 43. More specifically, the expansion ring 44 is disposed between the toroidal housing 42 and the toroidal inner housing 56. The expansion ring 44 is generally cylindrical in shape, having disposed on a portion of its inner surface an expansion ring gear 46 (see FIG. 14). The expansion ring gear 46 and that corresponding portion of the expansion ring 44 are generally disposed within an expansion ring gear race 48 formed in the toroidal housing 42 (best seen in FIGS. 17-18). The race 48 provides a bearing surface for the expansion ring 44. The race 48 is a substantially cylindrical-shaped groove having a diameter slightly smaller than the diameter of the expansion ring gear 46. The depth of the race 48 is determined largely by the application employed by the rotary machine 40. In relatively high speed, low torque applications the race depth may be slightly greater than in a lower r.p.m. application. The guiding principle regarding race 48 design is to provide a guide track to help maintain the rotational movement integrity of the expansion ring 44.

The type of bearing (not shown) employed to carry relative motion of the rotary components varies with the application. In the preferred high speed, low torque embodiment roller bearings would be employed. However, other bearings are considered within the scope of this invention, for example, ball, tapered, air, liquid metal and magnetic bearings. Similarly, in a high torque, low speed application carbon (graphite) bushings are preferred. Again, however, other bearings are considered within the scope of this aspect of the invention, for example, ceramic composites, oil impregnated composites and bronzes, carbon impregnated composites, carbide composites and powdered metal composites.

Further, in the preferred embodiment, located on an inner surface of the expansion ring 44 is an expansion ring projection 50 (FIG. 14). The expansion ring projection 50 is radially formed on an inner surface of the expansion ring 44. The projection 50 extends substantially from an inner surface of the expansion ring 44 to the toroidal inner-housing wall 60 (FIG. 14). Additionally, disposed within the expansion ring 44, and consequently within the toroidal housing 42, is a sealing cylinder 62. The sealing cylinder 62 is mechanically connected to the expansion ring 44 via the expansion ring gear 46 and the sealing cylinder gear 66. In a similar manner as discussed above, the sealing cylinder gear 66 rides in a sealing cylinder race 67 (see FIG. 17). Also, the sealing cylinder 62 has located on its outer periphery, at an end opposite the sealing cylinder gear 66, a sealing cylinder recess 64 (FIG. 14). The sealing cylinder recess 64 is shaped and located to mechanically mate with the expansion ring projection 50 at designated intervals.

Other expansion ring 44 designs are considered within the scope of this invention. More specifically, the arrangement of the expansion ring within the housing may have the ring 44 located on an inward portion of the space 110 with the projection 50 extending outwardly (not shown). Likewise, the ring may be disposed approximately in the center of the space 110 with projections 50 extending inwardly and outwardly (not shown). Thus, any possible arrangement of ring 44 and projection 50 is considered within the scope of the invention.

The gearing relationship between the sealing cylinder 62 and the expansion ring 44 as well as the relative rotational movement of the rotary components are also adjustable. In the preferred embodiment, for relatively high torque applications a lower gear ratio is typically preferred. For example, a one-to-one ratio of sealing cylinder 62 and expansion ring 44 speed is desirable. Conversely, for relatively higher speed lower torque applications, a higher ratio may be employed, for example, one-to-ten expansion ring 44 to sealing cylinder 62 ratio may be used. The above ratios are examples of various ratios employable by this rotary machine, however, any other ratio is considered within the scope of this invention to achieve any desired output.

Another aspect of this invention is the variable relationship of the rotary components. In the preferred embodiment shown in the FIGURES, the ring 44 and cylinder 62 rotate in the same plane. However, other mechanical connections may be employed to permit rotation of the ring 44 and cylinder 62 in different planes. Various gearing combinations (not shown) or other mechanical means commonly known in the art, may be employed such that rotation of the ring 44 may occur is planes other than the plane of rotation employed by the cylinder 62.

In the preferred embodiment, the sealing cylinder 62 has at its cylindrical axis a sealing cylinder projection 68 extending axially outward from each end of the sealing cylinder 62. The sealing cylinder projections 68 extend outside of the toroidal housing 42 and the cover 43 to provide both clockwise and counterclockwise rotation outside of the rotary machine 40. In an alternative embodiment, the projection 68 may extend from only one side of the sealing cylinder 62. In this manner, a more compact rotary machine 40 can be built, or specific rotational power can be achieved.

In the preferred embodiment, the sealing cylinder projection 68 that extends through the toroidal housing 42 also controls the valve port 86 opening timing. The valve port opening timing is controlled via a high-speed gear 82 and a low-speed geared valve 84. The high-speed gear 82 is joined to the projection 68 and rotates with rotation of the projection 68. Also connected to the high-speed gear 82 is the low-speed geared valve 84, which has a valve port 86 disposed there through. Further, disposed through a surface of the housing 42 and in an area encompassed by the geared valve 84 is an intake port 74 (FIG. 14). The rotation of the geared valve 84 via the high-speed gear 82 causes an intermittent alignment of the valve port 86 and the intake port 74, allowing introduction of combustion products.

Further disposed on a surface of the housing 42 is an ignition device 88, which is integrally connected with an ignition port 76 (see FIG. 14). The preferred embodiment employs a spark plug as a ignition device 88. However, any other ignition device 88 commonly known in the art is employable with this device. For example, transformer discharge systems, voltage devices, photoelectric cells, piezoelectric, and plasma arc devices are within the scope of this invention. Also, disposed through a surface of the toroidal housing is an exhaust port 78.

The ignition port 76 (see FIG. 14) is relatively spaced to the intake port 74 to provide efficient interaction of the ignition and intake products. As disclosed in the various FIGURES, the ignition port 76 is located in a rotationally counterclockwise position relative to the intake port 74. In the preferred embodiment the inlet port spacing is as near the sealing cylinder 62 as possible, including overlapping the sealing cylinder 62. In alternative embodiments, however, it is recognized that the relative positions of the intake port 74 and the ignition port 76 may vary. Also, the ports may be of any size or shape, for example, the ports may be round, square, triangular or oval. The relative size of the ports is dependent upon the time available for mass transfer to occur and the amount of mass transfer necessary in a given application. A plurality of ports may also be employed to achieve desired operating conditions. Further, the relative ports may be employed at an angle relative to the surface of the chamber (not shown). In this manner, the intake and ignition products are propelled in an advancing direction with the expansion ring 42.

Yet, another design consideration of this invention is material choice. In the preferred embodiment, the rotary machine 40 is constructed of high temperature steel or any steel alloy. However, other materials are considered within the scope of this invention, for example, titanium, nickel and nickel alloys, carbon based composites, carbide composites, powdered metal composites, ceramics, ceramic composites, ferrous and non-ferrous metals.

FIG. 14 further discloses the relationship of the variety of components of the rotary machine 40. Bearing surfaces on an inner surface of housing 42 support the expansion ring 44. As stated above, a portion of the expansion ring 44 and the expansion ring gear 46 are supported by the expansion ring race 48 in the toroidal housing 42. The inner surface of the expansion ring 44 and the sealing cylinder wall 70 and a substantially toroidal housing wall 60 and projection trailing edge 52 define an inner space 71. Located within the inner space 71 are the intake port 74, ignition port 76 and exhaust port 78.

Extending radially across the inner space 71 is the expansion ring projection 50. The inner edge of the expansion ring projection 50 and the toroidal inner housing wall 60 form a movable, substantially airtight seal therebetween. Further, the sealing cylinder wall 70 is substantially in sealable contact with the expansion ring 44 at the contact area 72. The contact area 72 forms a substantially sealed separation between the intake port 74 and the exhaust port 78.

The toroidal inner-housing wall 60 bearingly supports the sealing cylinder 62 via a substantially c-shaped toroidal inner housing cutout 58. The c-shaped toroidal inner housing cutout 58 provides support for rotating sealing cylinder 62. As discussed above, a sealing cylinder race 67 is formed in the relative portion of the inner housing wall 60 of the inner housing cutout 58, wherein the sealing cylinder race 67 provides rotational stability for the sealing cylinder 62.

The inner housing cutout 58 and the sealing cylinder wall 70 are spaced relative to one another such that free rotation of the sealing cylinder 62 is allowed while providing a substantially airtight seal between the cylinder 62 and housing 58. Similarly, the points or terminal ends of the cutout 58 extend peripherally around the sealing cylinder 62 to points beyond the intake and exhaust ports, 74 and 78 respectively. In this manner, the geometry of the inner housing cutout 58 helps seal the space between the housing 58 and the sealing cylinder 62.

A removed area 65 is also shown. The removed area 65 serves a plurality of functions. First, the removed area decreases the overall weight of the rotary machine 40, which serves to increase the power-to-weight ratio of the machine 40. Also, the removed area 65 serves to increase the surface area of the machine 40, thus increasing the heat transfer capabilities of the machine 40 thereby allowing the machine 40 to operate at cooler temperatures. The removed area may be of any geometric shape. For example, oval, circular, lobed or other geometries are within the scope of this disclosure. Furthermore, cooling fins, or tubes, (not shown) may be disposed within the removed area 65, thus further increasing the rotary machine's cooling ability.

As discussed above, all prior rotary engines have suffered from side-sealing problems, with pressurized gases leaking around the ends of the drive rotor cylinder. The leakage is an overall energy loss to the system adversely effecting the efficiency of the engine. The removed area in combination with the toroidal housing 42 shape prevents any cross leaking from high-pressure area to a low-pressure area. The toroidal housing design effectively removes the ends, thereby making side-sealing problems an impossibility.

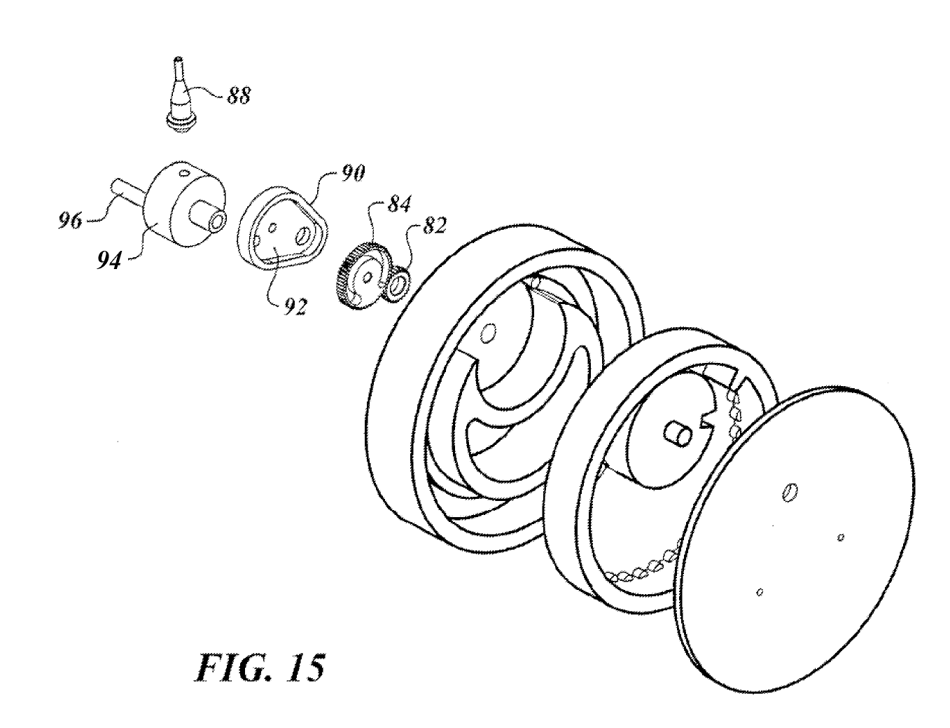

FIG. 15 depicts the rotary machine 40, employed as an external combustion engine. Located on an end opposite of the cover 43 are external combustion components. The external combustion components are mechanically and fluidly integrated with the rotary machine 40. Extending over, and substantially enveloping the intake port 74 (see FIG. 14), high-speed gear 82 and geared valve 84 is a manifold and drive valve cover 90. On an external surface of the manifold and drive valve cover 90 is a manifold firing inlet 92. The manifold firing inlet 92 is mechanically and fluidly connected to an external combustion chamber 94. The external combustion chamber 94 is integrally connected with an ignition device 88 and a fuel/air admission device 96.

The rotary machine may include a plurality of external combustion chambers 94. For example, a manifold 90 may be employed to receive expanding combustive products from several external combustion chambers. The multi-combustion manifold (not shown) is designed to direct the combined combustive products through the intake port 74 in a manner similar to the single external combustion embodiment of this invention. However, with the multi-combustion chamber embodiment, the manifold shapes the respective shock waves produced, such that the respective waves substantially cancel themselves. The overall effect of the multi-combustion chamber embodiment is an increased internal pressure within the increasing space 110 relative to the single combustion chamber embodiment. More specifically, the plurality of external combustion chambers function to increase the overall volume of expansive gases, and thus internal pressure of the rotary machine 40.

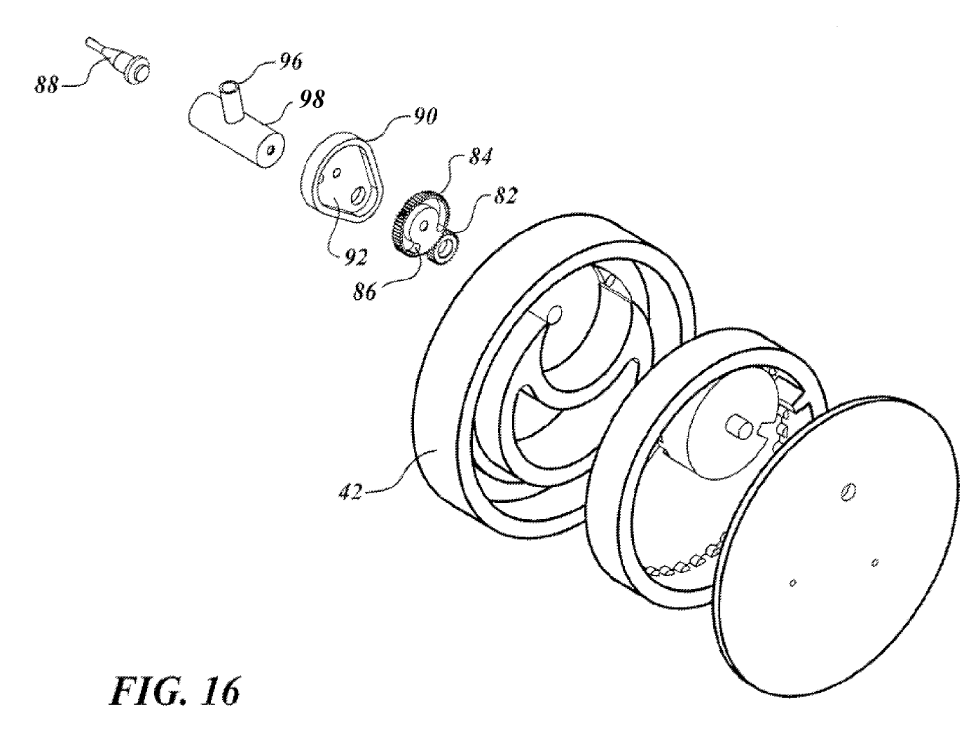

FIG. 16 depicts an alternate embodiment of an external combustion rotary machine 40. In this embodiment, the external combustion chamber 94 is replaced with a shaped charge or other detonation cycle chamber 98. The shaped charge or other detonation cycle chamber 98 comprises at least one each of a fuel/air admission device 96 and an ignition device 88. In this aspect of the invention, a shaped compression wave or pulse compression wave is propagated within the cycle chamber 98 and fluidly transported into the toroidal housing 42 to produce work from the rotary machine 40. Though one shaped charge or other detonation cycle chambers 98 is shown in FIG. 16, as with the external combustion chamber embodiment, the use of several shaped charge chambers 98 is within the scope of this invention.

The general shape of either the external combustion chamber 94 or the detonation cycle chamber 98 is variable and either may be of any internal or external geometry. The general shape of either chamber may be manipulated to achieve a desired pressure or some other desired nature of the pressure or compression wave.

FIG. 17 depicts a sectional view of the rotary machine 40. The housing 42 surrounds and is in bearing contact with the expansion ring 44. Likewise, the expansion ring projection 50 is in substantially sealing contact with the inner housing wall 60. Additionally, the sealing cylinder 62 is nested in the c-shaped inner housing cut-out 58 and is in sealing bearing contact with the expansion ring 44 at the sealing cylinder contact area 72. The sealing cylinder projections 68 are disclosed as extending from respective axial surfaces of the sealing cylinder 62. The projections 68 extend through the housing 42 and cover 43, respectively.

FIG. 18 is an additional sectional view of a portion of the rotary machine 40. The high-speed gear 82 is attached to a sealing cylinder projection 68. The high-speed gear 82 is mechanically connected to the geared valve 84. Depending upon the application, the high-speed gear 82 and the geared valve 84 function as either the drive gear or the driven gear. For example, when the rotary machine is employed as an internal combustion engine, the expansion ring 42 and sealing cylinder are driven in a counterclockwise manner as a result of combustion. The rotation of the sealing cylinder 62 yields a rotation of the projection 68 that drives the rotation of the high-speed gear 82. The high-speed gear 82, as the drive gear, transfers the rotational displacement to the geared rotary valve 84, thus controlling the valve port 86 timing. Conversely, when the rotary machine 40 is employed as a fluid pump, the geared valve 84 controls the introduction of the fluid and thus, control of the valve action dictates the relative movements of the internal components. Thus, the geared valve 84 drives the high-speed gear 82.

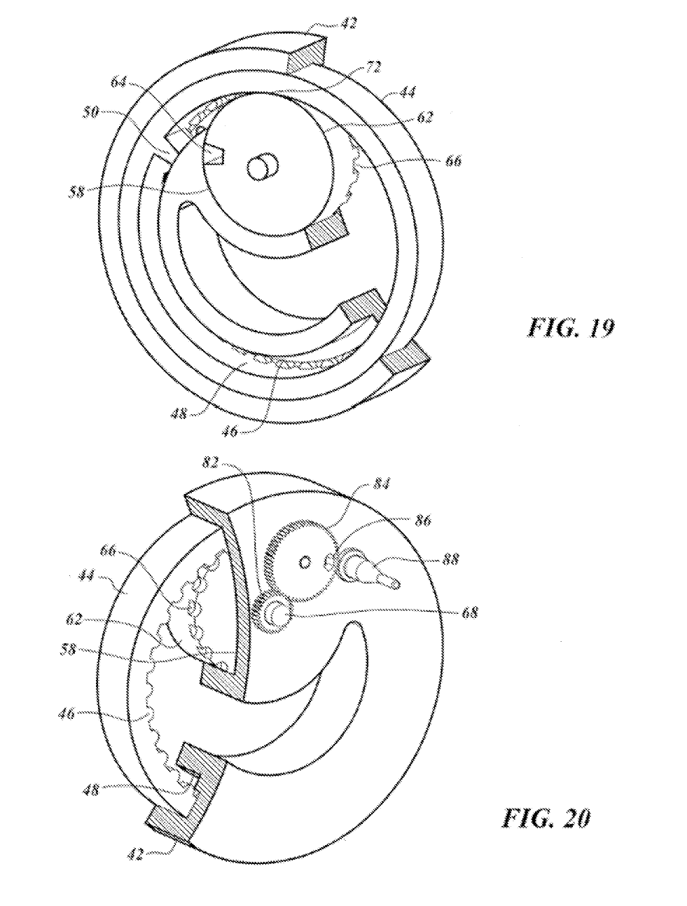

FIG. 19 provides another view of the bearing relationship between the toroidal housing 42 and the expansion ring 44. In a similar fashion, the bearing relationship between the sealing cylinder 62 and the inner-housing cutout 58 is illustrated. The expansion ring gear 46 and a portion of the expansion ring 44 are maintained in the expansion ring race 48. The expansion ring race, in combination with the inner wall of the toroidal housing 42, maintains the disposition of the expansion ring within the housing while permitting free rotary motion of the ring 42. A similar relationship exists between the inner housing cutout 58, sealing cylinder 62 and expansion ring 44.

FIG. 20 further discloses the mechanical relationship between the sealing cylinder 62, expansion ring 44, high-speed gear 82, geared valve 84 and valve port 86. Relative motion between the expansion ring 44 and the sealing cylinder 62 is transmitted between the two components via the expansion ring gear 46 and sealing cylinder gear 66, respectively. Likewise, any rotary motion of the sealing cylinder 62 is transmitted to the geared valve 84 via the sealing cylinder projection 68 and high-speed gear 82. As a result, the timing of the opening and closing of the valve port 86 is coupled with the relative orientation of the sealing cylinder 62 and the expansion ring.

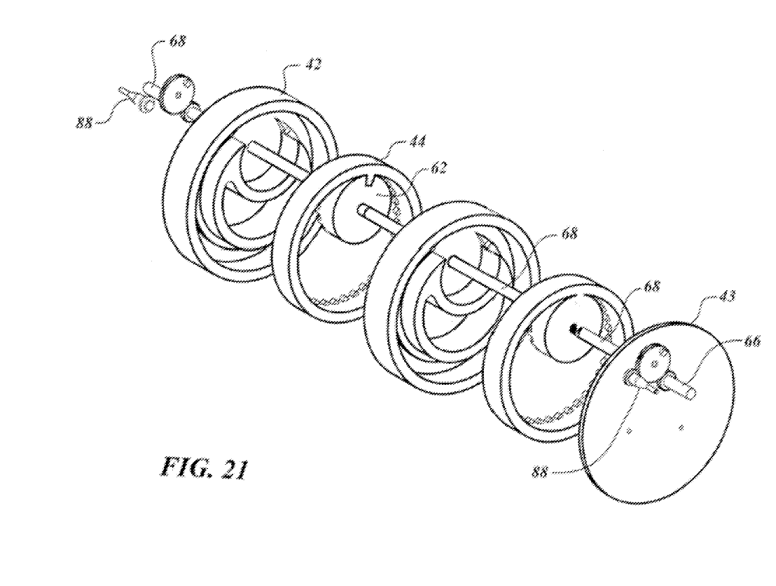

FIG. 21 depicts a multi-cylinder embodiment of this invention. This aspect of the invention discloses multiple cylinders disposed upon common axis, such as a single sealing cylinder projection 68. In this manner, any number of cylinders can be joined to attain a desired power output. The multi-cylinder embodiment of this invention anticipates a plurality of operating states. For example, a four cylinder rotary machine is operable with one, two, three or all four cylinders firing—the firing state being a function of the power requirement. The cylinders not firing are in a freewheel mode wherein their mass simply increases flywheel mass, and thus the angular momentum of the rotary machine.

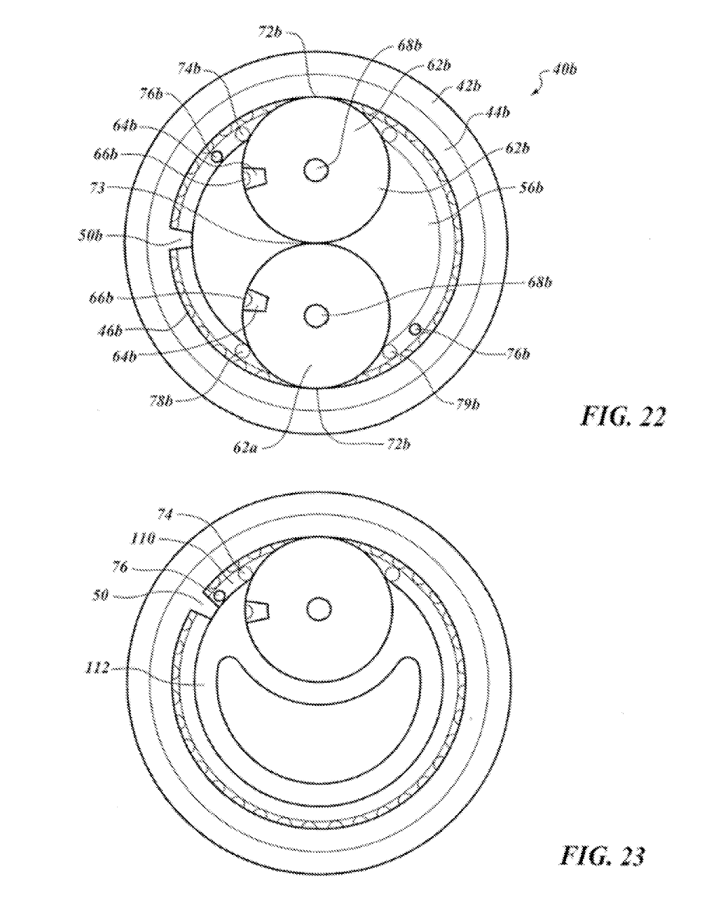

FIG. 22 depicts a rotary machine 40 (b) with multiple cycles per expansion ring 44 (b) rotation. The interrelationship of the various components of this embodiment is substantially the same as the single firing per expansion ring 42 rotation discussed above. This embodiment depicts two firing cycles per revolution of the expansion ring 44 (b). In the preferred embodiment, this is accomplished by substantially similar sealing cylinders 62 (a) and (b) traversing the internal diameter of the expansion ring 44 (b). The sealing cylinders are mechanically connected to each other and the expansion ring via a sealing cylinder gear 66 (b) and expansion ring gear 46 (b). Each respective sealing cylinder 62 (b) forms a contact area 72 (b) with the expansion ring 44 (b). The contact areas 72 (b) divide the rotary machine 40 (b) into substantially equal work-producing areas. Each work-producing area comprises an intake port 74 (b), ignition port 76 (b) and exhaust port 78 (b). A full thermal cycle takes place in each work-producing area, producing two expansion or power strokes per expansion ring revolution.

In the preferred embodiment depicted in FIG. 22, the firing of the ignition devices (not shown) is sequential. Thus, when the expansion ring projection 50 (b) reaches a counterclockwise position relative to each ignition port 76 (b), an ignition takes place. The expanding combustive products drive the expansion ring 44 (b) until they exit through exhaust port 78 (b). The expansion ring projection 50 (b) then passes through mated contact with the sealing cylinder recess 64 (b) and into a second ignition position.

It is anticipated that the expansion ring 44 (b) may have a plurality of expansion ring projections 50 (b), thereby permitting simultaneous ignition of the combustion products. Further, it is within the scope of this invention to further increase the number of work producing areas within a single expansion ring 44 (b) rotation. For example, a third or fourth sealing cylinder may be introduced to increase the number of work-producing areas correspondingly.

Cycles—Internal Combustion Engine:

This invention creates a new thermal cycle for engines. The new cycle is intake, power and exhaust. Thus, the new thermal cycle does not have a compression stroke robbing power from the system while simultaneously limiting the work produced by preheating the initial charge. Likewise, the cycle allows for full gaseous expansion during the power stroke by exhausting gases at or slightly above atmospheric pressure. Thus, nearly all power loss is removed while maximizing the work produced by the cycle. Listed below is a more detailed description of various aspects of the new engine cycle. Further, following the internal combustion aspect of this invention, additional aspects of this invention are disclosed in detail.

FIG. 23 discloses the rotary machine 40 at an approximate intake state in the engine cycle. The expansion ring projection 50 is shown counterclockwise past the intake port 74 and ignition port 76 to define a space 110 and space 112. As the ring projection 50 moves counterclockwise, a plurality of precisely timed events take place. The sealing cylinder 62 is rotationally displaced, which ultimately controls the rotation of the geared valve 84. At a dedicated time (discussed below), the rotation of the geared valve 84 brings into alignment the valve port 86 and the intake port 74. As alignment is achieved, the combustion products are introduced into the space 110 and subsequently ignited by the ignition device 88.

The combustion products are introduced into the space 110 either at atmospheric pressure or at a compressed state. In the preferred embodiment, the combustion products are introduced at between one to twenty-five atmospheres. However, any other combustion product pressure is considered within the scope of this invention. When combustion products are introduced at atmospheric pressure, or without pre-compression, they are simply drawn into the space 110 by a vacuum created by the counterclockwise displacement of the expansion ring 44. The overall efficiency of the rotary machine 40 is slightly decreased when combustion products are introduced at approximately ambient pressure. However, when operated in this mode, the intake port 74 is larger in diameter, thereby decreasing the flow resistance and permitting maximum fluid transport into the space 110. In a similar manner, the valve port 86 may be of slightly increased size, allowing a slightly longer intake cycle.

Pressurized combustion products can also be introduced into the space 110. In the preferred pressurized embodiment, a fuel pump pressurizes the combustion products. However, any other commonly known means for pressurizing fluids is within the scope of this invention. The overall process of introducing the combustion products into the space 110 is substantially the same as discussed above. However, as the combustion products are being introduced under pressure, the positive pressure of the combustion products drives the fluid transfer into the space 110, not a negative pressure created within the space 110 as above. Also, the rate at which the fluid transfer occurs is generally quicker than the vacuum induction embodiment discussed above. Thus, the relative size of the valve port 86 is preferably smaller than the valve port 86 dimensions used in the above embodiment.

The inlet air may be pressurized by a fan, blower, or super charger (not shown) to accommodate higher cycle speeds and combustion pressure. The power to operate these devices may be drawn from the rotation of the sealing cylinder projection 68, by manipulation of the exhaust gases (discussed below) or by other means commonly known in the art. Distinct from the Otto cycle engines, the pressurization of the combustion products does not take place within the combustion area, or space 110; the pressurization is created externally. In this manner, piston momentum is not lost in the pressurization process, therefore yielding a more efficient engine cycle.

In yet another preferred embodiment, a combination of fuel and air may be mixed internally, within space 110, by drawing air only through the intake valve and injecting fuel directly into the space 110 by use of a direct cylinder injector (not shown). This combination of pressurized injection of fuel and vacuum-induced air has additional advantages over other embodiments. The ratio of fuel to air may be manipulated to achieve a desired combustion rate. The ratio may be manipulated by adjusting port sizes or injection pressures and ignition timing (discussed below). By mixing the combustion products in the space 110, the possibility of intake manifold fires is eliminated.

The angle of the axis of the intake port 74 relative to the expansion ring's 44 cylindrical axis may be varied to provide additional rotational encouragement of the expansion ring 44. More specifically, in either the vacuum induction embodiment or the pressurized embodiment discussed above, the intake port may be angled such that the combustion products are directed into the trailing edge of the expansion ring projection 50 (angled ports not shown). In the pressurized embodiment, by directing the combustion products in the direction of rotation, the majority of the combustion products, and thus the greatest resulting combustive pressure wave, is generated as closely as possible to the projection 50. Thus, the combustion more efficiently transfers the resulting chemical energy of the combustive products into mechanical energy via the expansion ring 44.

In the preferred embodiment, the valve means is a rotary geared valve 84. However, other valve means are considered within the scope of this invention, for example, solenoid controlled, poppet, slide, flapper, disc, cam actuated, drum, reed, desmobromic cam, gate, check and ball valves. Regardless of the style of valve employed, the valve must operate to efficiently transfer fluids into the space 110. The valve choice is largely determined by the application of the rotary machine 40, such as faster acting valves for higher speed applications.

At the rotary state approximated by FIG. 23, combustion products are introduced into the space 110. The precise timing of the combustive product introduction is controlled by the valve, however, the overriding valve design is controlled by the relative intake and the expansion volumes—the expansion ratio. More specifically, as disclosed in FIG. 23, the ratio between the volume of combustive products introduced into space 110 and the expansion value possible through space 112 defines the expansion ratio. In the preferred embodiment, an expansion volume that is approximately 3-4 times the intake volume is optimal. This allows nearly complete expansion of the combustive gases, thus maximizing the work performed by the combustion process. However, independent selection of expansion ratios within the scope of this invention. In this embodiment, the combustive products are exhausted at approximately ambient pressure. However, as it is sometimes desirable to have slightly pressurized exhaust gases, the expansion ratio can be manipulated to achieve a desired exhaust gas state.

At a controlled time after the introduction of the combustion products, the intake port 74 is closed and the ignition device 88 fires the combustion products in the increasing space 110. The resulting combustion greatly increases the pressure within the increasing space 110, which forces the expansion ring projection 50 away from sealing cylinder 62, beginning the power stroke.

The timing of the combustion product ignition is also a variable to be manipulated to achieve specific rotary machine 40 efficiency. For example, ignition early in the intake process corresponds with a relatively smaller space 110, thus a higher initial combustive pressure within the space 110 is attained as well as a slightly higher expansion ratio. Conversely, when the rotary machine 40 ignition is set at a time further advanced in the cycle, a larger space 110 exists. Thus, for an identical machine, a lower combustive pressure is attained and a slightly smaller expansion ratio is attained.

The ignition timing is also based on the relative location of the intake port 74 and ignition port 76. In all embodiments, the ignition port is in the rotational direction away from the intake port. In this manner, the combustion products, whether pressurized or not, flow over the ignition port 74. In a preferred embodiment, the ignition is timed to fire approximately in the middle of the combustive products as the combustive products pass over the ignition port 74. In this manner, a more complete initial combustion takes place, providing a relatively faster pressure increase. However, the timing may be set to fire at approximately the leading edge of the combustive products, or perhaps the trailing edge of same. In each case, a slightly different combustion rate is achieved, yielding varying internal pressures. Further, the ignition timing is preferably continually adjustable during operation of the rotary machine 40. More specifically, the timing may be advanced or retarded based on engine speed or loading requirements.

The ignition timing and relative port location, design and size allow for the combustion product volume to be independent from sealing cylinder projection 68 r.p.m. requirements. More specifically, as discussed above, gearing relationships may be employed to yield a projection 68 velocity independent of the volume of the combustive charge employed. In this manner, the specific combustive charge volume is independent of the size of the engine. Also, the relative speed of the expansion ring 44 and the projection 68 may be manipulated to achieve any desirable relative speed between the two components.

The chemical composition of the fuel also affects performance of the rotary machine 40 and thus the timing of the valve means and the ignition means. Different fuels have different combustion rates. Therefore, the relative timing of the valve means and ignition means will vary to optimize efficiency. The preferred embodiment employs gasoline as a fuel source. However, any other fuel commonly known in the art is employable with this device. For example, hydrogen, methane, propane, kerosene, diesel, butane, acetylene, octane, fuel oil, all explosive gases or combustible liquids, carbon cycle fuels (as dust), combustible metals (as dust) and others are within the scope of this invention.

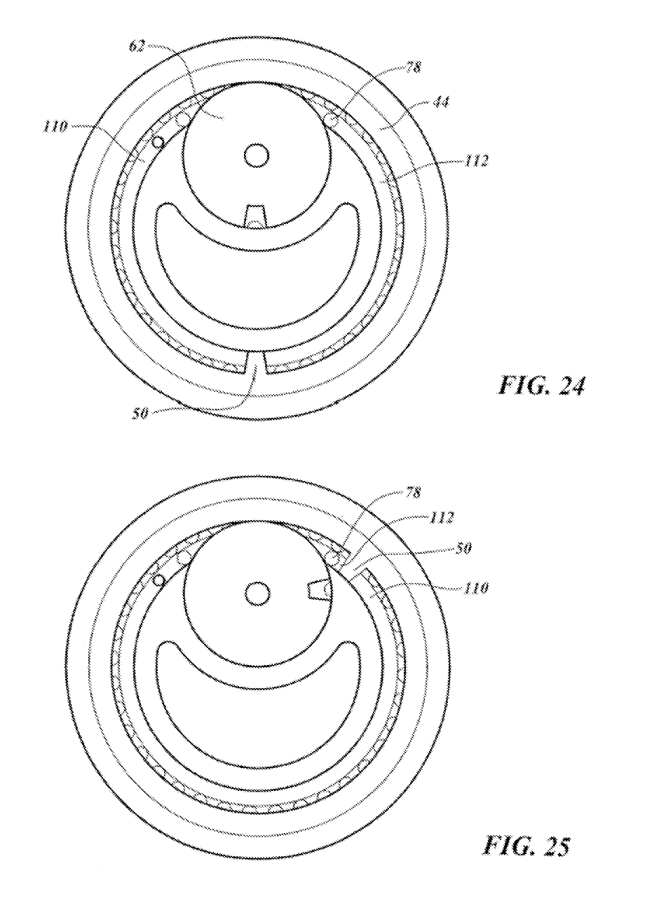

FIG. 24 shows the expansion ring 44 and the inner sealing cylinder 62 each rotated in a counterclockwise direction due to the combustion related pressure increase within the increasing space 110. During the power state, the internal pressure within the increasing space 110 decreases with the increasing volume of the space 110. As the expansion ring 44 rotates, the sealing cylinder 62 is likewise driven in a counterclockwise direction. Thus, the projection 68 rotates and yields a rotational power source outside the housing 42. An even and consistent expansion of the combustive products is desired in the preferred embodiment of this invention. Generally, even expansion, or a controlled oxidation rate, is achieved through control of the timing of ignition, composition of the fuel and the relative locations of the intake port 74 and ignition port 76 as discussed above. However, other design aspects of this invention are utilized to maximize efficient use of the combustive gases, for example, geometric design of the combustion and expansion space 110.

The geometric design of the space 110 where the combustion takes place, and consequently the geometry of the projection 50, is shaped to maximize the conversion from chemical to mechanical energy. More specifically, the preferred embodiment as shown in the FIGURES discloses the space 110 as generally a cylindrical hoop within the housing 42. The hoop structure is designed to allow not only a smooth entrance and dissipation of combustion products, but also a minimally restrictive expansion area. The smooth expansion area of increasing space 110 encourages an efficient rate of propagation of the flame during ignition and a desirable swirling of the gases during expansion. The mono-directional rotation of the expansion ring 44 and the relatively smooth inner surface of the space 110 minimize inertial loss of the expanding combustive products. Additionally, the geometry of the preferred embodiment prevents power-robbing multiple detonations during a single cycle by allowing smooth fluid transfer during combustion. Any other geometry for the space 110 and projection 50 is considered within the scope of this invention.

FIG. 25 discloses an advanced stage in the expansion cycle. At this point, the expansion cycle is nearly complete and nearly all of the available work is harvested from the expanding gases. Depending upon the desired embodiment employed, expansion ratios and fuel employed, the pressure in the increasing chamber 110 is approximately at or above ambient pressure. For embodiments designed to have expansion gases at approximately ambient pressure, substantially all available expansive work is recovered by this new thermal cycle. In certain preferred embodiments it is desirable to employ an expansion cycle wherein the combustion products are above ambient pressure when the exhaust cycle begins. In this manner, exhaust gases are available to do work separate from driving the rotational movement of the sealing cylinder projection 68. For example, pressurized exhaust gases may be directed into a turbo charger or other air pump (not shown) that will in turn pressurize the combustion products prior to their entrance into the space 110. Likewise, the exhaust gases may drive a turbine (not shown) to generate electrical power or be used in combination with other structures (not shown) as a heating source. Naturally, any fluids ahead of the leading edge of the projection 50 will be driven out of the space 112 by the rotating expansion ring 44. Thus, expansion products at ambient pressure are slightly pressurized just prior to exhaust. However, manipulation of the exhaust port size and geometry is anticipated to achieve desired exhaust pressures. For example, where it is desired to exhaust gases at slightly above ambient pressures, a larger, less restrictive exhaust port 78, or a plurality of ports 78 (not shown), may be used. Conversely, the port size may be relatively smaller when a more pressurized exhaust fluid is desired.

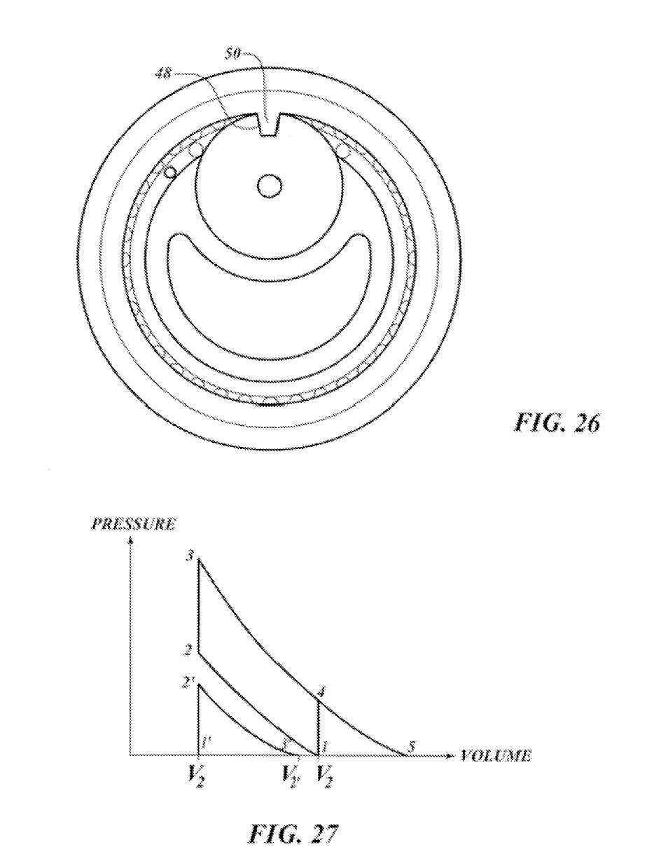

FIG. 26 shows the completed thermal cycle of the internal combustion embodiment of this invention. Here, the expansion ring projection 52 is mechanically mated with the inner sealing cylinder recess 48. From this point, the cycle is ready to begin again.

This new thermal cycle is free from the inertial mass changes that haunt the efficiency of the standard Otto cycle engine. Further, there is no significant preheating of the combustive products, thereby allowing the cycle to harvest the maximum expansive work from the combustion process. Likewise, there is no, or extremely minimal, loss associated with compression of the combustion products.

Analysis of Pulsed Rotary Combustion Engine

An independent analysis of the new thermal cycle was performed, demonstrating its improved efficiency.

Overview: Thermal-cycle analyses have been performed on the rotary pulsed combustion engine. Analysis was performed on embodiments with pre-compression of the combustible charge and without. In particular, a concept was analyzed whereby the volume compression ratio preceding combustion was exceeded by the volume expansion ratio following combustion. Comparisons were made with the classical Otto cycle for reciprocating (or Wankel) internal spark ignition combustion engines. The internal combustion (IC) engines are constrained by the design to have the compression volume ratio identically equal to the expansion ratio. The inherent advantage of the pulsed rotary combustion engine is that the expansion ratio can exceed the compression ratio, allowing additional conversion of the thermal energy to useful work.

Analysis: A classical thermal cycle analysis examines the path in a pressure (p) versus volume (V) plot for a charge of combustible mixture. The area inside the path line on the plot is the amount of work obtained from the original charge of combustible mixture. That is, the work W=∫pdV. The ratio of that work to the amount of chemical energy associated with the charge yields the thermal efficiency (after multiplying by 100%).

The cycle involves intake shown as Point 1 in FIG. 27, compression (Path 1-2), combustion (Path 2-3), expansion (Path 3-4 or 3-5 during which work is extracted), and exhaust (Path 4-1 or Point 5). Work is performed on the charge during compression but it is less than the work extracted so that the net work is indeed positive. During the compression and expansion strokes, no heat is added or subtracted so that an adiabatic process is followed. Thereby the quantity
pV^{γ} (1)
remains unchanged during each process; γ has a value between 1.36 and 1.40. The charge is predominantly air by weight or volume; air at room temperature has the γ value of 1.40. It will decrease slightly with increasing temperature so that we can expect it to vary between 1.40 and 1.36 during compression. We take an average value in our calculations. The combustion product gases will have a still lower value of γ for two reasons: higher temperature and the presence of triatomic molecules such as carbon dioxide and water vapor. For the product gases, an average value of γ=1.3 or so can be expected.

In the model cycle, the intake process involves the entrance of gases at normal atmospheric pressure p₁ and volume V₁. Compression (Path 1-2) involves increasing pressure and temperature and decreasing volume according to the adiabatic law. Then combustion (Path 2-3) occurs at constant volume with an increasing pressure and temperature. Expansion (Path 3-4 or 3-5) involves increasing volume with decreasing pressure and temperature according to the adiabatic law. Finally exhaust occurs with the gases still at an elevated temperature (Point 4 or 5). The pressure at the beginning of the exhaust is higher than the atmospheric pressure if the exhausted volume equals the intake volume. Since the pressure at exhaust equals atmospheric pressure, the exhaust volume must be much larger than the intake volume.

In comparing the various engine cycles, we will use the same fuel with the same value for chemical energy Q per mass m of the combustible mixture at stoichiometric proportions for fuel and air. The realistic value of 6.50 is taken for the quantity Q/(mcₚT₁) where cₚ and T₁ are the specific heat and the intake temperature. This means that the chemical energy (Q) of the intake mixture is 6.5 times greater than its initial thermal energy (mcₚT₁). When the combustion occurs, the chemical energy is converted to thermal energy so that
Q=mcₚ(T₃−T₂)=mcₚ(T_{2′}−T₁) (2)

Note that T_{1′}=T₁, which is the normal temperature of air in the atmosphere.

We consider a perfect gas so that we may employ the law
pV=mRT (3)

to relate pressure, volume, and temperature. M is the mass of the charge and R is the specific gas constant. With the Equations (2) and (3), we can determine the fractional pressure increase during the constant volume process.

$$\begin{matrix}\frac{{p}_{3} - {p}_{2}}{{p}_{2}} = \frac{Q}{m {c}_{p} {T}_{2}} \\ or & ( 4 a ) \\ \frac{{p}_{{2}^{′}} - {p}_{1}}{{p}_{1}} = \frac{Q}{m {c}_{p} {T}_{1}} = 6.5 & ( 4 b )\end{matrix}$$

Equations 3), 4a) and 4b) can be combined to give

$$\frac{{p}_{3} - {p}_{2}}{{p}_{{2}^{′}} - {p}_{1}} = \frac{{V}_{1}}{{V}_{2}} = CR \qquad ( 5 )$$

where the volume ratio CR is known as the compression ratio. Typically, CR values for automotive engines are in the 9 to 11 range while power tools have typical ratios of 7 to 8.

We can use Equation (1) for the compression process to show that

$$\begin{matrix}{p}_{1} {V}_{1}^{γ} = {p}_{2} {V}_{2}^{γ} \\ or & ( 6 a ) \\ \frac{{p}_{2}}{{p}_{1}} = {CR}^{γ} & ( 6 b )\end{matrix}$$

Note that Equation (4b) and (6b) show that a value of CR=4.22 or greater will cause the pressure p₂ to be larger than the value p_{2′} as indicated in FIG. 27. p and V in Equation (6a) can take any value along the path 1-2 in FIG. 27.

During the expansion process, Equation (1) also applies and yields
p₃V₃^{γe}=p₄V₄^{γe}=p₅V₅^{γe}=pV^{γe} (7)
where p and V can take any value along the path 3-4-5 in FIG. 27. γe is the ratio of specific heats for the exhaust gases which, as noted earlier, can take different values than the γ for the intake gases.

The net work W performed for each charge of the thermal cycle is the work extracted during the expansion process minus the work performed on the charge during the compression. For the Otto cycle, we have
W_{IC}=∫_{V}_{₃}^{V}^{₄}pdV−∫_{V}_{₁}^{V}^{₂}pdV (8)

That is, the net work equals the area within the closed path 1-2-3-4-1 of FIG. 27. Equation (7) can be used to relate p to p₃, V₁, and V. Then the calculus of integration can be used.

We obtain the result for the classical internal combustion engine Otto cycle that

$$\begin{matrix}\frac{{W}_{IC}}{{p}_{1} {V}_{1}} = \frac{1}{γ e - 1} [ 1 + \frac{Q}{m {c}_{p} {{T}_{1} ( CR )}^{γ - 1}} ] [ {( CR )}^{γ - 1} - {( CR )}^{γ - γ e} ] - \\ \frac{1}{γ - 1} [ {( CR )}^{γ - 1} - 1 ]\end{matrix} \qquad ( 9 )$$

For the proposed rotary engine, the net work will be given by
W_{RE}=∫_{V}_{₅}^{V}^{₅}pdV−∫_{V}_{₁}^{V}^{₅}pdV−p₁(V₅−V₁) (10)

that is, the net work equals the area in FIG. 27 enclosed by the path 1-2-3-5-1. Now, again using Equation 7) and 8), the integration can be performed yielding

$$\begin{matrix}\frac{{W}_{RE}}{{p}_{1} {V}_{1}} = \frac{1}{λ e - 1} ( 1 + \frac{Q}{m {c}_{p} {{T}_{1} ( CR )}^{γ - 1}} ) \\ {( CR )}^{λ e - 1} - \frac{1}{( γ - 1 )} [ {( CR )}^{γ - 1} - 1 ] + \\ 1 - {( 1 + \frac{Q}{m {c}_{p} {{T}_{1} ( CR )}^{γ - 1}} )}^{( 1 - γ e ) / γ e} {CR}^{[ γ / γ e - 1 ]}\end{matrix} \qquad ( 11 )$$

Clearly, the value of W_{RE} will exceed the amount of W_{IC} by the area enclosed by the path 4-5-1-4 in FIG. 27.

For the classical Otto cycle, the volume at the end of the expansion equals the intake volume; that is V₄=V₁. For the rotary-engine cycle, it can be shown that

$$\frac{{V}_{5}}{{V}_{1}} = {( 1 + \frac{Q}{m {c}_{p} {T}_{1} {CR}^{γ - 1}} )}^{\frac{1}{γ e}} {CR}^{γ / γ e - 1} \qquad ( 12 )$$

Therefore, the volume at the end of the expansion can be much greater than the exhaust volume.

It can be shown that, without pre-compression, the work obtained by the rotary engine is the area enclosed by the path 1′-2′-3′-1′ in FIG. 15. In particular, we obtain

$$\begin{matrix}\frac{{W}_{NC}}{{p}_{1} {V}_{2}} = \frac{1}{γ e - 1} [ 1 + \frac{Q}{m {c}_{p} {T}_{1}} ] \\ [ 1 - {( 1 + \frac{Q}{m {c}_{p} {T}_{1}} )}^{( 1 - γ e ) / γ e} ] - [ {( 1 + \frac{Q}{m {c}_{p} {T}_{1}} )}^{1 / γ e} - 1 ]\end{matrix} \qquad ( 13 )$$

In equations (9), (11), and (13), the net work is presented on the left side of the equation in a form where it is divided (or normalized) by the product of the intake pressure and the intake volume for the particular engine. The work of the engine would increase in proportion to the volume of each intake charge. So naturally, a larger engine would do more work. The power of the engine would be predicted by multiplying W by the number of firings per revolution of the engine (1 for the rotary engine and ½ for the reciprocating four-stroke engine) and then multiplying again by the engine revolutions per unit time. If the work W is given in foot-pound units and the engine speed is given in rpm, the theoretical horsepower rating can be obtained by dividing the product by 33,000. That is

$$\begin{matrix}{HP}_{RE} = \frac{W \cdot rpm}{33000} \\ and & ( 14 a ) \\ {HP}_{IC =} \frac{W \cdot rpm / 2}{33000} & ( 14 b )\end{matrix}$$

Note that these are ideal evaluations that do not account for heat losses and mechanical losses. They are useful formulas, though, for making the first evaluations to compare the different engines.

The right sides of Equations (9), (11), and (13) can be calculated after specifying only the four values that we have already discussed: Q/mcₚT₁, CR, γ, and γe.

| Case | n̅ | γ | | CR | $\frac{{W}_{IC}}{{p}_{1} {V}_{2}}$ | $\frac{W}{{p}_{1}}$ | $\frac{W}{{p}_{1}}$ | $\frac{{V}_{5}}{{V}_{1}}$ |
|---|---|---|---|---|---|---|---|---|
| | 6.5 | 38 | | 9 | 11.01 | 5 | 1 | 3 |
| | | | .28 | | | .718 | 3.546 | .447 |
| | 6.5 | 38 | 1.28 | 7 | 10.156 | 5 | 1 | 3 |
| | | | | | | .718 | 2.923 | .507 |
| | 6.5 | 38 | 1.28 | 11 | 1 | 5 | 1 | 3 |
| | | | | | 1.77 | .718 | 4.138 | .290 |
| | 6.0 | 1.38 | 1.28 | 9 | 1 | 5 | 1 | 3 |
| | | | | | 0.191 | 0.91 | 2.448 | .231 |
| 5 | 6 | | 1 | 9 | 1 | 5 | 1 | 3 |
| | .5 | .40 | .28 | | 0.78 | .718 | 3.135 | .358 |
| | 6 | | 1 | 9 | 1 | 5 | 1 | 3 |
| | .5 | .38 | .30 | | 0.722 | .577 | 2.986 | .269 |
| | 6 | | 1 | 9 | 1 | 5 | 1 | 3 |
| | .5 | .40 | .30 | | 0.79 | .577 | 3.12 | 939 |

Results: Calculations were performed for the seven cases shown in the table. Comparisons were made for three engine cycles: Otto cycle for the reciprocating engine, rotary engine cycle with the same compression ratio as the Otto cycle, and a rotary engine cycle without pre-compression but otherwise with the same parameters of the other two cycles. The work outputs for each of the cycles and the expansion-volume-to-intake-volume ratio for the rotary-engine cycle are shown in the table. Sensitivities of the results to variations in the four input parameters can be seen from the table.

Sensitivity to the compression ratio is seen by comparing Cases 1, 2, and 3. While work output increases with the compression ratio, the advantage of the rotary-engine cycle (with pre-compression) decreases as the compression ratio increases. Still, the rotary-engine cycle has a distinct advantage. The work output advantage of more than 20% comes with the disadvantage of a larger volume.

The value of Q/mcₚT₁=6.5 is typical for stoichiometric mixtures of the combustible charge. An off-stoichiometric mixture is simulated in Case 4. A decrease in work output is seen, but the relative advantage of the rotary engine is about the same when Cases 1 and 4 are compared.

The sensitivities to the values for the specific heats can be seen by comparing results for Cases 1, 5, 6, and 7. Increases in the values of γ and γe will decrease the work output for both cycles, but the relative advantage of the rotary engine cycle is maintained.

As a reference for the conversion of work output to power, Equation 14 can show that a value of W/p₁V₁=13 for a 3000 rpm engine with one liter (about 61 cubic inches) of combustible intake charge at atmospheric pressure yields 88.3 horsepower. This, of course, is a theoretical value that does not account for heat losses and mechanical friction.

A further advantage to the rotary machine 40 and thermal cycle is the ability of the machine 40 to operate in a variety of configurations. The machine is employable as an external rotary combustion engine, fluid compressor, vacuum pump, drive turbine, and drive turbine for expandable gases or pressurized fluid. A more detailed discussion of various configurations is provided below.

External Combustion Engine:

FIG. 15 depicts one possible external combustion engine configuration. The only significant distinction between the internal and external combustion engine configurations is the location of combustion chamber 94. In this mode the combustion takes place outside of the housing 42 in an external combustion chamber 94, wherein the expanding gases produced from combustion are passed through the intake port 74 into the increasing space 110. Further, as combustion takes place outside of the housing, the ignition port 76 is either plugged or does not exist. The various rotary states illustrated in FIGS. 23-26 are otherwise the same as in the above internal combustion configuration. Further, fuel and air is mixable externally in all examples by traditional means such as carburetors or port-type fuel injectors.

External Combustion Engine with a Shaped Charge or Detonation Cycle Chamber:

FIG. 16 depicts one possible external combustion engine with a shaped charge or detonation cycle chamber configuration. This configuration is similar to the standard external combustion assembly above. However, here a shaped charge or other detonation cycle chamber 98 generates a compression wave to drive the rotary machine 40. Due to the extremely high pressure resulting from compression wave propagation, the rotary machine 40 is driven at much higher pressures than possible in a typical Otto cycle engine. As with the external combustion configuration, FIGS. 23-26 are illustrative of a complete thermal cycle of this invention.

In the External Combustion examples discussed above, more than one combustion chamber may be used. This will be useful to cancel detonation or shaped charge shock waves by placing two chambers opposite one another and firing them simultaneously.

Further, in all combustion engines disclosed above, the engine may be linked to additional engines to create multi-cylinder engines. The engine would be able to shut down the cylinders not required in low load conditions and increase the number of cylinders firing as the load condition increase—a fuel saving option not available on other engines. The engines not firing become flywheels when not firing.

A Gas or Air Compressor:

In this example, the driving cylinder becomes the inner sealing cylinder 44, which is rotated by a force applied externally to the sealing cylinder projection 68, and an exhaust valve (not shown) controls exhaust port 78. Additionally, the inlet port is continuously open. As illustrated in FIGS. 23-26, the sealing cylinder 62 and the expansion ring are driven in a counterclockwise direction. The rotation and closed exhaust valve compress the fluid products in the decreasing space 112 while drawing in a new charge in the increasing space 110. At a time approximated by FIG. 25, the exhaust valve opens, allowing the expulsion of the compressed fluids from the exhaust port 78. In starting the next cycle, a new charge of gas is brought in through the inlet port 74. A greater compressed gas volume is achieved by connecting more than one compressor in series, wherein the exhaust of one becomes the intake of another. In this manner, extremely high compression values are attainable.

Vacuum Pump:

FIGS. 23 through 26 show a vacuum pump cycle. The vacuum pump cycle is similar to the gas or air compressor cycle described above, except that the inlet valve 84 is located on the inlet port as opposed to the exhaust port (as in the air compressor configuration). In this fashion, the inlet valve 84 keeps the inlet port 74 closed until such time as the expansion ring projection 68 moves past the inlet port 74 in a counterclockwise direction, at which time the inlet valve 84 opens the inlet port 74 and the movement of the expansion ring creates a vacuum or negative pressure in the increasing space 110, thereby drawing in fluid products through the inlet port 54. As with the air compressor configuration above, a greater vacuum is attainable by linking a plurality of cylinders together.

Fluid or Water Pump (Pressure Type):

This configuration functions in the same manner as the air compressor above. However, the fluids in this configuration are liquid and are therefore generally incompressible. Consequently, the fluids will exit the cylinder as a unit volume into a tank or chamber (not shown) to be pressurized by compressing gases above the fluid level.

Fluid or Water Pump (Suction Type):

In a manner similar to the vacuum pump disclosed above, this rotary machine is capable of functioning as a fluid or water pump (suction type). In this mode, the inlet valve is located to control the timing of fluid products (liquid) entering the inner space.

Drive Turbine for Expandable Gases or Air:

The rotary machine 40 is capable of being used as a drive turbine for expandable (compressed) gases or air. This aspect of the invention allows the rotary machine 40 to be used as either a pulse or an economy type drive turbine. In this mode, gases or air are admitted into the increasing chamber 110 as the expansion ring projection 68 passes over inlet port 74. Gases are admitted through inlet valve 84. The gases admitted are compressed and a certain unit volume of gas is admitted per cycle. The compressed gas entering increasing chamber 110 forces both the expansion ring 44 and the inner sealing cylinder 62 to displace in a clockwise direction such that the increasing chamber 110 increases in size as the expansion ring 44 moves. When the expansion ring completes one full cycle and passes over the exhaust port 78, the volume of gas or air is back down to atmospheric pressure. Thus, the total work applied to the piston is realized. In this configuration, rotary power is taken from the sealing cylinder protrusion 68 and applied to an outside component to do work.

Drive Turbine for Liquids (Pressurized):

This is similar to the drive turbine for expandable gases or air disclosed above. Pressurized liquid is injected through the inlet valve 84 as the expansion ring projection 68 passes the inlet port 74. The inlet valve is opened, and due to the general incompressibility of liquids, the valve remains open for the complete cycle. FIG. 16 illustrates a geared valve 84 with elongated valve port 86 controlling the inlet fluids. In this configuration, pressurized liquid forces the expansion ring 44 one complete cycle until such time as it is exhausted out of the exhaust port 78.

Combinations of the Above:

The above configurations are combinable to produce a variety of results. For example, multiple sealing cylinders can be combined, one providing a degree of compression for the intake of the other. Also, gas compressors are combinable with fluid compressors. Virtually any combination of the above configurations is considered within the scope of this invention.

In accordance with yet another embodiment of the invention, the biological generation of hydrogen from water has been developed to create a highly efficient combustion engine that would burn cleanly off of a sustainable fuel source.

Certain bacteria, which grow in the absence of air (anaerobic bacteria), and green algae, have the ability to produce hydrogen gas from water. This complex system involves a biological catalyst, an enzyme, and several co-factors (substance or coenzymes required by the enzyme). Most of these organisms require the presence of sunlight for the production of hydrogen as this process is very similar to photosynthesis. It has been demonstrated by others that some bacteria can produce the hydrogen from water without the required sunlight if an additional chemical is present. The trouble with these systems is that the by-products are highly toxic. The present invention provides for a Light Independent (dark) Hydrogen Generation System (LIHGS), which involves the optimization of the bacterial generation systems by manipulation of the cofactor conditions, as well as the choice of chemical used, resulting in no toxic by-products. The final system is a “free-standing” bio-reactor which only requires the presence of water and certain organic and inorganic materials for the generation of hydrogen. This invention provides a major step forward to enable the “hydrogen economy.”

LIHGS has distinct advantages over current and proposed methods for the generation of hydrogen from water. Current methods for the generation of hydrogen from water include electrolysis, hydrolysis of sodium borohydride and green algae systems. The electrolysis system and the sodium borohydride system are quite expensive, and the green algae systems require the presence of sunlight and simply do not produce enough hydrogen.

In one embodiment of the invention, hydrogen is produced from water in a light independent (dark) procedure. A chemical treatment process of water to produce electrons and protons is combined with a biological system containing hydrogenase enzyme(s) to generate the hydrogen.

In yet another embodiment of the invention, a cell free extract of an anaerobic microorganism is a hydrogen producer placed in a dialysis bag, suspended in an aqueous system containing sodium dithionite (dithionite) and methyl viologen (DT/MV system). The cell free extract serves as the source of the hydrogenase enzyme(s), dithionite is the reducing agent to generate electrons and protons from the water, while the methyl viologen serves as the electron carrier for the hydrogenase enzyme(s).

Hydrogen has been well recognized as the fuel of the future. It has high energy value and its products are nonpolluting. However, current methods to produce hydrogen use fossil fuels and high temperatures to produce the hydrogen. Furthermore, these methods produce carbon dioxide and NOₓ, thus negating any environmental advantages. Biological processes to produce hydrogen are intriguing, but considerable technical challenges still exist. A major challenge is to have high rates of hydrogen production and still use an inexpensive energy source for the biological production. Photosynthetic methods can employ solar radiation, but the hydrogen production is too slow to be of use. Fermentation methods can produce hydrogen at high rates, but require expensive energy sources such as glucose. Biomass would seem to be ideal as source of glucose, however, the problem with biological hydrogen production is the same as with biological ethanol production from biomass: inefficient degradation of the cellulosic material containing the glucose.

The present invention is directed to an alternative source for hydrogen production: the synthesis of hydrogen from water based on the ability of a component or components of the chloroplast, either Chloroplast Photosystem 1 and/or Chloroplast System II. Illumination of the system enables the chloroplast photosystem(s) to form molecular oxygen, hydrogen ions and electrons from water. An electron carrier such as, but not limited to ferrodoxin or methyl viologen is used to transport the electrons from PSI or dithionite to the hydrogenase enzyme.

In 1998 it was reported by McTavish (McTavish. H., “Hydrogen Evolution By Direct Electron Transfer From Photosystem I To Hydrogenases,” 1998 J. Biochem. (Tokyo) 123:644-649) that hydrogen evolution was observed by direct electron transfer from the dithionite-reduced photosystem I (PSI) complex to both hydrogenase 1 and hydrogenase IT from Clostridium pasteurianum. In addition, this reaction was reported to occur in the dark. Elimination of the photosynthetic step in the generation of biological hydrogen make this invention more competitive with traditional fuel cell systems or other hydrogen generation systems, such as sodium borohydride.

In a further embodiment of the invention, a light independent (dark) hydrogen generating system consists of a combined chemical/biological process, wherein dithionite is used as the reducing agent which will generate electrons and protons from water. A cell-free extract of a hydrogen-producing microorganism will then convert the protons into molecular hydrogen with methyl viologen being the electron carrier.

A small (10 mL) hydrogen producing system consisting of a gas-tight test tube with an aqueous system containing dithionite and methyl viologen into which will be suspended the dialysis bag with the cell free extract.

A baseline assessment of the hydrogen producing system was performed using dithionite and methyl viologen at one concentration each in the mM and u.M range.

source of aqueous system

buffered versus non-buffered aqueous system

concentration of dithionite

concentration of methyl viologen

pH

temperature

ionic strength

volume of cell free extract

amount of cell equivalents present in the cell free extract

detrimental effect of the DT/MV system on hydrogenase activity

Task 1—Selection of Anaerobic Hydrogen Producing Microorganisms

Anaerobic microorganisms for hydrogen production were screened. Clostridium septicum was grown in brain heart infusion broth. Other types of media, including defined media, may be superior as feedstock for the hydrogen producing microorganisms. The following two species of bacteria were used because of their reported copious production of hydrogen: Clostridium pasteurianum and Desulfovibrio vulgaris. The hydrogenases from these organisms have been studied quite extensively. Therefore there is ample information available on their behavior and stability. For instance, the hydrogenases of C. pasteurianum are fairly sensitive to oxygen while the hydrogenase enzyme system of D. vulgaris is believed to be more stable in the presence of oxygen. The sensitivity of these hydrogenase systems to oxygen was evaluated by hydrogen production under strict anaerobic conditions as well as in the presence of various levels of oxygen. Organisms were obtained from the American Type Culture Collection (ATCC).

The ability of the organisms to produce hydrogen was validated by analyzing the head-space of the culture tube using gas chromatography with molecular sieve columns and fitted with a TCD detector. The growth experiments were carried out in test tubes fitted with a Hungate screw cap containing 5 ml of pre-reduced and anaerobically sterilized (PRAS) medium. The expandable Hungate screw caps allowed for easy sampling for hydrogen production in the headspace. Viability was determined by optical density readings or by diluting, plating and counting of colonies. All these experiments were performed in an anaerobic chamber.

Task 2—Preparation of Cell Free Extract

Cell free extracts were prepared of the most efficient hydrogen producing bacterium identified in Task 1. The organism were grown overnight in the medium (100 ml) that is superior for generating hydrogen. The culture was harvested via centrifugation and resuspended at 10× or higher cell density in a balanced salt solution, such as Ringers or phosphate buffered saline. Two procedures for obtaining cell free extracts were evaluated: trench press and sonication. There was no need to fractionate the cell free extracts as there is good evidence to suggest that hydrogenase(s) is/are membrane bound. An estimate of the # number of cells that make up the cell free extracts was determined by diluting and plating of the overnight cultures prior to cell disruption.

Storage conditions of the cell free extract were evaluated. Freshly prepared cell free extracts were compared with extracts that were been stored in 100 to 1000 ul portions at −20° C. for their ability to generate hydrogen. This was done once the set-up with dialysis bag has been evaluated (See Task 3).

Task 3—Selection of Dialysis Bag

A series of dialysis membranes were evaluated, i.e., 2 or 3 MW distribution, ensuring the large molecules and fractions of the cells remained within the dialysis bag. However, smaller molecules such as NaCl (if seawater is used), methyl viologen (MW=257.16) and dithionite (MW=174.1) would freely permeate. A simple way to determine how well the dialysis bag is retaining crucial components of the hydrogen-producing system is to simply remove the dialysis bag from the tube and to determine whether hydrogen is still being produced in the DT/MV system.

Task 4—Design of Hydrogen Producing System

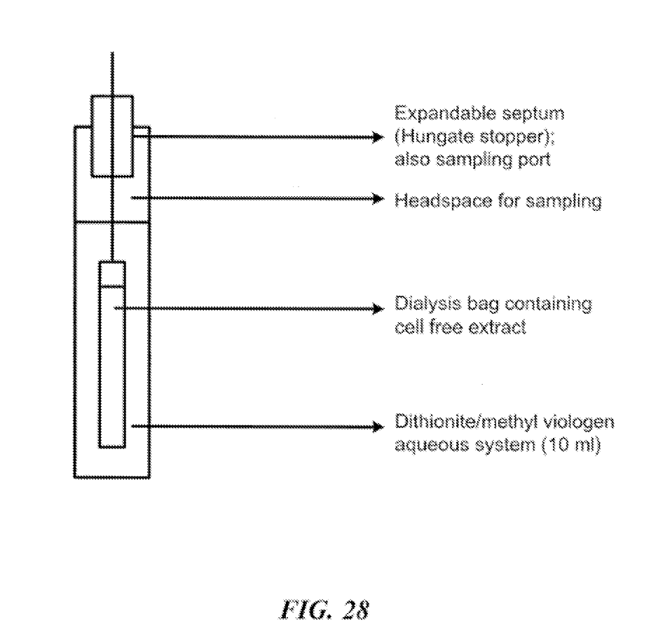

FIG. 28 illustrates the design of the hydrogen producing system. It consists of an airtight test tube with an expandable septum containing 10 mL of the DT/MV aqueous system. A small dialysis bag containing the cell free extract was be placed in DT/MV solution. The expandable septum consists of material that allows the insertion of hypodermic needles for sampling of the headspace for hydrogen, as well as sampling of the DT/MV system for evaluating of consumption of dithionite and methyl viologen reduction/oxidation (color change).

A series of experiments were performed with the hydrogen producing system in order to establish a basement assessment, the results of which were used to evaluate various parameters in Task 5. The basement assessment consisted of using two different assay conditions as reported in the literature spanning a 3 log concentration range for the dithionite and methyl viologen. The hydrogen generated inside the dialysis bag diffused out, which made it easy to monitor its production (See FIG. 28). Sampling the headspace of the hydrogen producing systems was performed.

The first assay will consist of the following conditions as described by McTavish (Mctavish. H., “Hydrogen Evolution By Direct Electron Transfer From Photosystem I To Hydrogenases,” 1998 J. Biochem. (Tokyo) 123:644-649):

0.5 M Tris-HCl, pH 8.3

100 mM NaCl

2 mM methyl viologen

5 mM sodium dithionite

5-100 mg cell extract in dialysis bag

Total reaction volume: 10 ml total

The second assay will consist of the following conditions described by Fitzgerald et al. (Fitzgerald, M., Roger. K. K. Rao and D. O. Hall., “Efficiency of Ferredoxins and Flavodoxins as Mediators in Systems for Hydrogen Evolution,” 1980. Biochem J. 192:665-672):

20 mM potassium phosphate, pH 7.0

5 μm methyl viologen

20 μm sodium dithionite (to start reaction)

5-100 mg cell extract in dialysis bag

Total reaction volume: 10 ml.

Task 5—Evaluation of Parameters for Optimum Hydrogen Production

Once the hydrogen producing system was in place we were able to evaluate various parameters that play a critical role in establishing the most effective hydrogen producing system. Whenever possible we used a matrix approach to evaluate the parameters listed below:

Source of water (seawater, fresh lake water or simply a HEPES-TRIS buffer system)

buffered versus non-buffered aqueous system

concentration of dithionite

concentration of methyl viologen

pH

temperature

ionic strength

volume of cell free extract

amount of cell equivalents present in the cell free extract

detrimental effect of the DT/MV system on hydrogenase activity

HPLC and ion chromatography were used to monitor the dithionite while the reduction/oxidation of methyl viologen was monitored by GC and a spectrometric system (color change). Hydrogen production was monitored by GC.

Figures describe below illustrate particular embodiments for a drying system. Embodiments include systems utilizing a reaction chamber to generate heat and pressurized gases, and alternate embodiments not requiring a reaction chamber. The reaction chamber based system drying moisture laden materials employs a reaction chamber to generate hot pressurized gas, a pressure feeder hopper to introduce moisture laden materials into the hot pressurized gas emerging from the reaction chamber, and a drying tube configured to evaporate moisture from and granulate the hopper-introduced materials. Drying systems not utilizing the reaction chamber employ pressure-feeding hoppers into a pressure containing reservoir, or a pressure reservoir having an ingress pressure-feeding hopper and an egress pressure hopper.

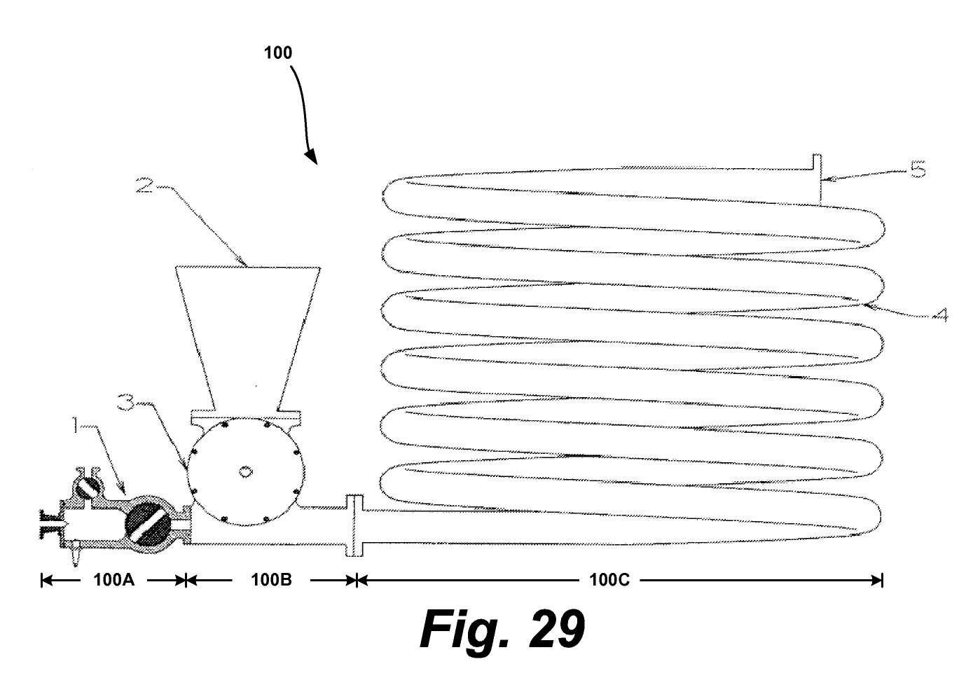

FIG. 29 is a side view schematic of a reaction chamber drying system 100. The reaction system 100 uses a reaction chamber 100A, a pressure feeder 100B, and a drying tube coil 100C. Heat and pressure are created by pulse combustion pressure and heat generated by the reaction of air and fuel introduced into the chamber 100A. Exhaust gases are fed through the lower or outlet side of the pressure feeder 100B and mixed with moisture laden suspensions feed from the hopper 2 into the hopper chamber 3 forming a material gas suspension. Thereafter, the material gas suspension is received into the drying tube coil due to pressure drop in tube 100C and centrifugally transits within the coil 4 to evaporate water from the material and to granulize the material as a consequence of ablation and abrasion with the outer wall of the tube coil 100C. The introduced material is dried or cooked by the heated exhaust gases from the reaction chamber 100A and particle sizes of the hopper-introduced material is reduced by ablation and abrasion with the tube outer wall. The reaction chamber system 100 is suited for drying, cooking, and fragmenting agglomerated materials.

Alternate embodiments include an in-process drying system having a reaction chamber configured to receive a heated gas, a feed hopper connected with the reaction chamber and configured to deliver wet material to form a gas-suspended wet material, a drying tube connected with the feed hopper such that the drying tube is configured to receive the gas-suspended wet material, and is shaped or configured in a manner that granulizes the gas-suspended wet material to hasten drying of the wet material while transiting through the drying tube in the heated gas.

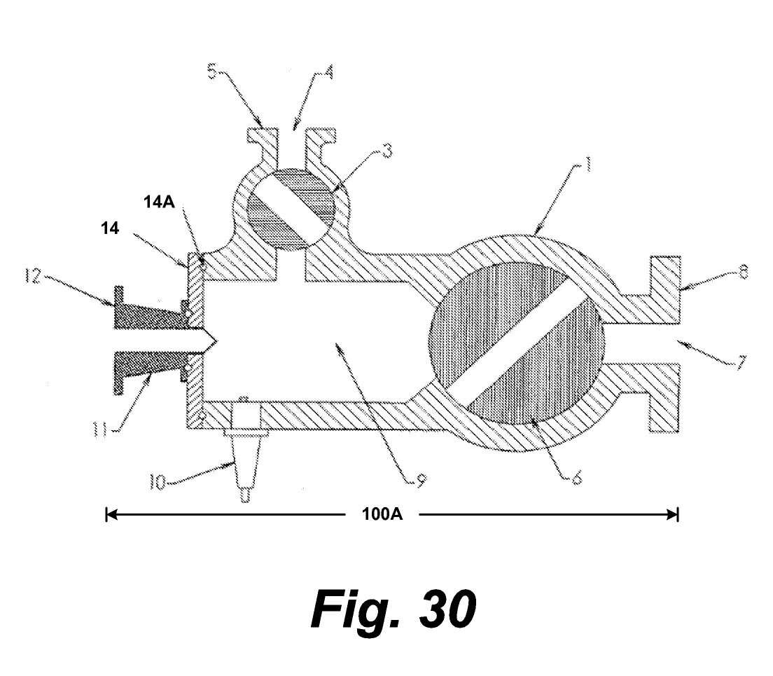

FIG. 30 is a cross-sectional view of the pulse combustion chamber device 100A. The chamber device 100A includes a housing bock 1, a removable plate or head 14, a plate head seal 14A, an air intake valve 3 (drive not shown), a pressurized air in-port 4, an air in-port flange 5, an exhaust valve 6 (drive not shown), an exhaust port 7, a exhaust port flange 8, a combustion chamber or space 9, a spark plug 10, a pressurized fuel injector 11, and a fuel injector flange 12. The reaction chamber 100A heating cycle begins with the exhaust valve 6 closed, the air intake valve 3 opens, the injector 11 open. Air and fuel are forced under pressure into the combustion chamber 9. Air intake valve 3 and fuel injector 11 are then closed. The combustible fuel and air mixture contained in the now enclosed combustion chamber 9 is ignited by spark plug 10 (or other ignition means). The ignited gas-air mixture expands by thermal expansion creating a significant pressure and exhaust gases are then delivered from the chamber 9 through the opened exhaust valve 6 and into exhaust port 7 that is connected to the inlet side of the drying tube 100C. Thereafter, another cycle begins with the closing of the exhaust valve.

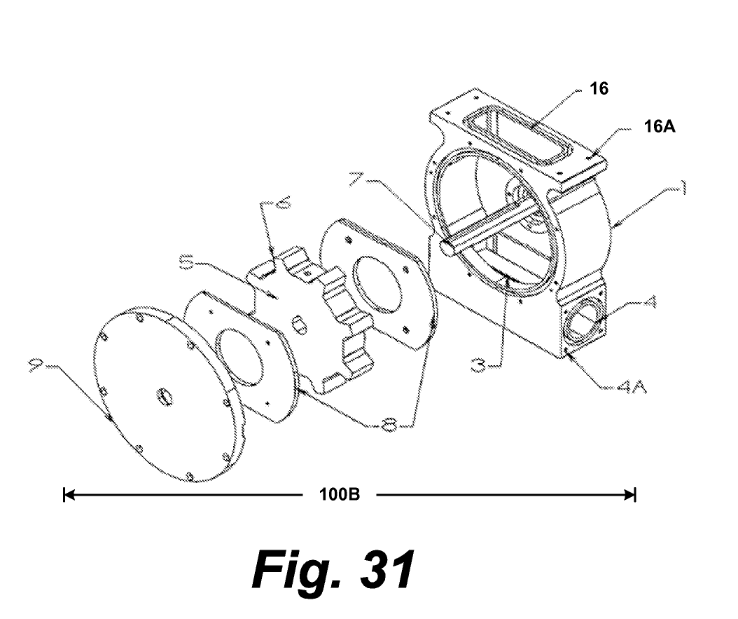

FIG. 31 is an isometric and exploded view of a pressure feeder 100B connectable with the combustion chamber 100A and drying tube 100C. The pressure feeder 100B is used to introduce materials for drying into the exhaust gases emerging from the pulse combustion chamber 100A. The pressure feeder 100B includes a housing or block 1, a material flow port 16, a flange connector 16A, a material outlet port 3, a tube port 4, and connector means 4A, a feeder rotor body 5, a rotor protection and sealing means 6, a drive shaft 7, two side seal plates 8, and a removable plate 9.

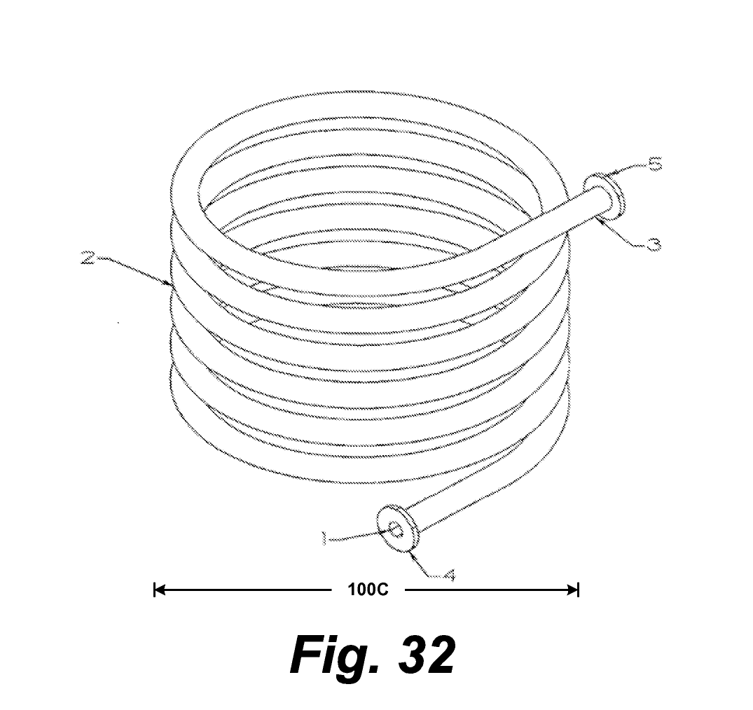

FIG. 32 is isometric view of a coil drying tube 100C connectable with the pressure feeder 100B of FIG. 31. Wet or damp material is fed under pressure combined with the heated gas stream into inlet port 1 connected to the exit port of the pressure feeder 100B. Bu pressure drop (outlet end of coil 3 is maintained at atmospheric or lower pressure than inlet port 1), the material and heated fluid or gasses medium pass through the coil at high speed. The high-speed flows caused by the pressure drop creates a centrifugal force within the coil tube 100C and granulizes the material particles into smaller particle sizes by ablation and abrasion against the outer inner walls of the tube coil. The heated fluid or gas medium by thermal transfer cooks or dries the wet, damp or moist material while inside the tube. The now cooked or dried material exits the outlet end of the coil 100C for separation by evaporation.

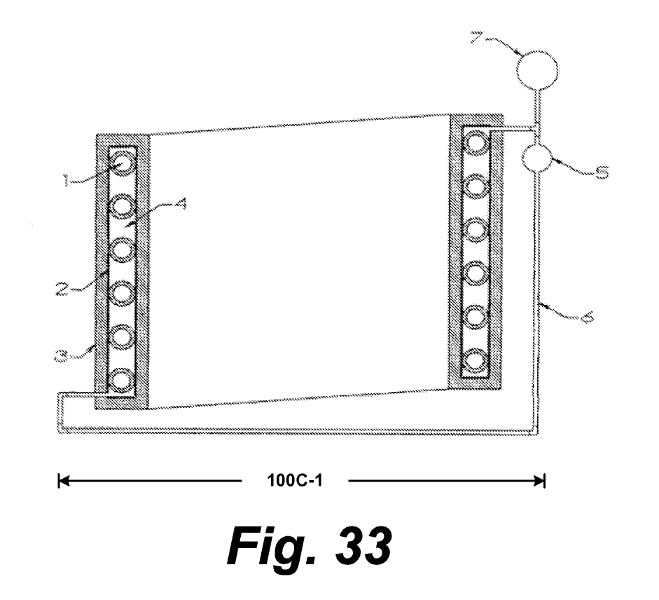

FIG. 33 is a side cross-sectional view of an alternate embodiment of the coil drying tube 100C-1 in thermal communication with a heating chamber enclosed within an insulating jacket 3. An inner space 1 of tube coil 100C-1 is heated by hot gas contained within jacket space 4. Jacket space 4 receives heat conducting fluid or gas that is regulated by gas pump 5 via circulating tube or pipe 6. Pressure of the medium within the jacket space 4 is regulated by gas expansion tank 7.

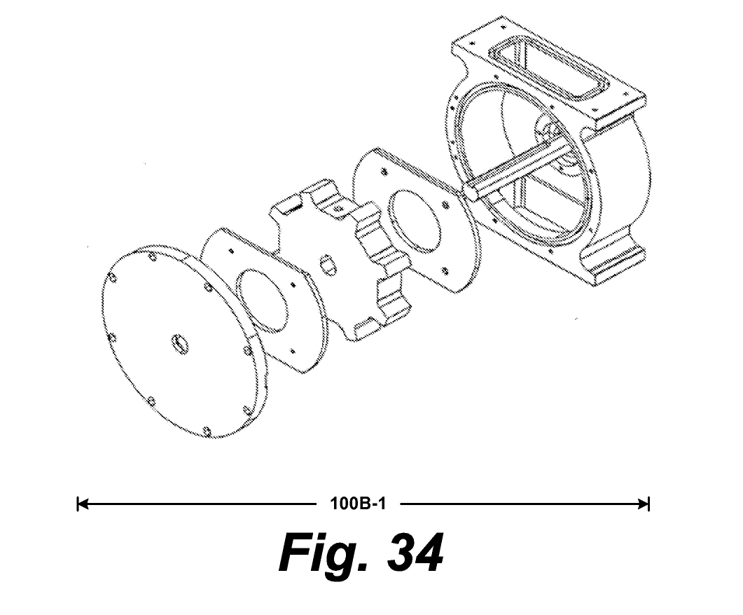

FIG. 34 is an isometric and exploded view side view of an ingress or egress pressure feeders 100B-1 connectable with a pressure reservoir. The ingress and egress feeders 100B-1 have the same components as the pressure feeder 100B, except there is not a tube port 4. Instead, there are two material flow ports 16. One flow port 16 is located on the topside, and the other flow port 16 located on the bottom side of the pressure feeder 100B-1.

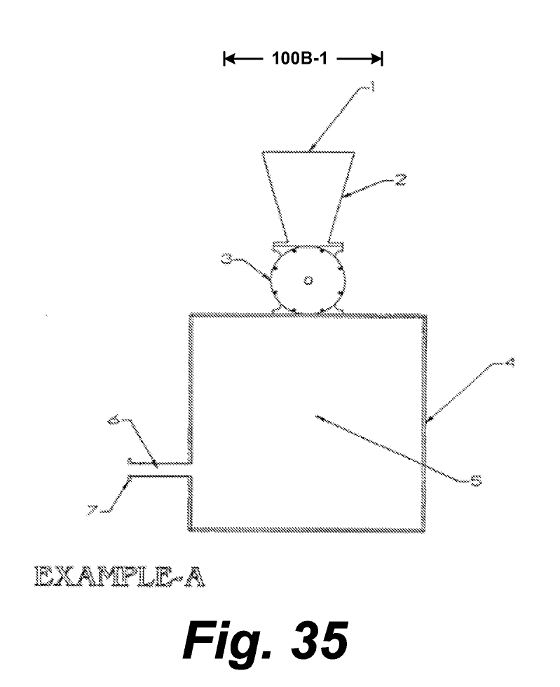

FIG. 35 depicts a side view and cross-sectional illustration of an ingress pressure feeder 100B-1 connected to a pressure reservoir 4. The pressure reservoir 4 receives pressurized drying gas from pressure inlet tube 6 that is connectable with a gas source (not shown) via connecting flange 7. A hopper funnel 2 is connected with the chamber assembly 3. Moisture laden material is introduced from the ingress pressure feeder 100B-1 and exposed to the drying gas in chamber 5. Water is removed and the material is directed to an exit port (not shown) having a lower pressure than the pressure in the chamber 5. Other operations as shown in example A of FIG. 7 advantageously allows the feeding and metering of material from low pressure environments into spaces or containers at an elevated pressure without allowing the pressure in the space or container to escape. This configuration is suitable for batch operation of steam pressure cookers, pressurized process tubes, combustion product dryers, pressurized fluids or gas steams, and heat or air dryers.

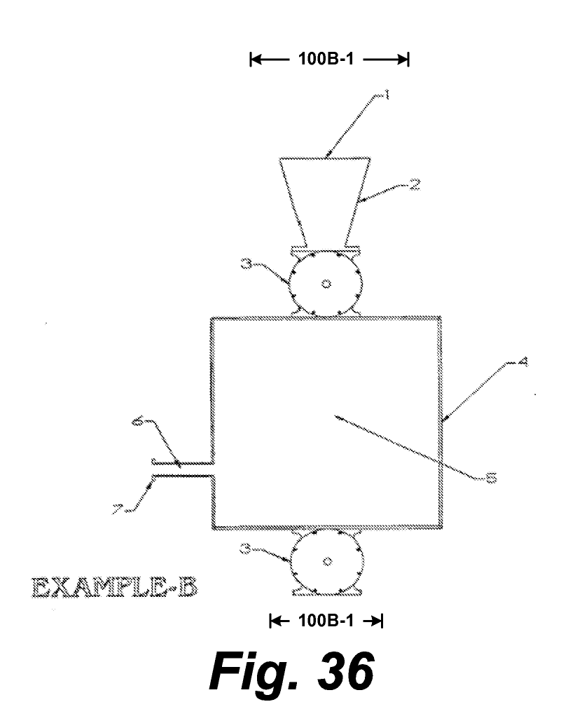

FIG. 36 depicts a side view and cross-sectional illustration of an ingress and egress pressure feeder drying system connected to a pressure reservoir. Similar in function to the batch operation of FIG. 7, this configuration is suitable for continuous operation as the top side ingress feeder 100B-1 feeds into chamber 5 and is pressurized, followed by the removal of the pressurized material with bottom side egress feeder 100B-1.

While the preferred embodiment of the invention has been illustrated and described, many changes can be made without departing from the spirit and scope of the invention. For example the reaction chamber based drying system 100 may be configured for continuous and batch operation. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A shaped charge engine, comprising:
an inner housing;
an outer housing joined to the inner housing to define a plurality of blast-forming regions, each of the blast-forming regions having a primary convergence zone;
a plurality of fuel injectors adapted to inject fuel into each of the blast-forming regions; and
a central opening in the inner housing to define a secondary convergence zone in fluid communication with the primary convergence zone,
whereby gas charges acquire a shape dictated by the primary convergence zone and a thrust conferred by the secondary convergence zone.

2. A two-cycle engine comprising:
a combustion chamber having an ignition source, a fuel injector, and an exhaust port;
a crankcase assembly;
an air intake chamber separated from the crankcase assembly and continuous with the combustion chamber and being in fluid communication with an air source and the combustion chamber; and
a piston located between and in slidable and sealable contact with the combustion and intake chambers, the piston having articulating contact with the crankcase assembly;
whereby piston movement towards the combustion chamber delivers an air charge from the carburetor to the intake chamber and causes the crankcase assembly to move, and crankcase movement causes the piston to move towards the intake chamber and delivers the air charge to the combustion chamber for ignition with fuel delivered by the fuel injector and venting of expanding gases through the exhaust port.

3. A method of thermal cycle applied for a combustion engine comprising:
introducing intake products into a space without compression in an intake stroke;
igniting the intake products in a power stroke to produce combustive products;
introducing intake products at approximately ambient pressure into a space without compression in an intake stroke;
producing ignition products in a power stroke; and
exhausting the ignition products in an exhaust stroke.

4. A drying system comprising:
a reaction chamber configured to deliver pressurized and heated gas;
a pressure hopper configured to introduce moisture laden materials into the gas to form a material gas suspension; and
a drying tube configured to receive the material gas suspension, and
wherein water is evaporated from the material and the material is granulized.

5. The system of claim 4, wherein the drying tube is a coil.

6. An in-process drying system comprising:
a reaction chamber configured to receive a heated gas;
a feed hopper connected with the reaction chamber containing a wet material to form a gas-suspended wet material; and
a drying tube connected with the feed hopper configured to receive the gas-suspended wet material,
wherein the gas-suspended wet material becomes granulized while transiting through the drying tube to hasten drying of the wet material in the heated gas.
